(19) United States
(12) Patent Application Publication
(10) Pub. No.: US 2018/0081454 A1
(43) Pub. Date: Mar. 22, 2018

(54) INFORMATION INPUT PEN AND INFORMATION INPUT SYSTEM

(71) Applicant: SHARP KABUSHIKI KAISHA, Sakai City, Osaka (JP)

(72) Inventors: Tamiyo NAKABAYASHI, Sakai City (JP); Yan QIAN, Sakai City (JP)

(73) Assignee: SHARP KABUSHIKI KAISHA, Sakai City, Osaka (JP)

(21) Appl. No.: 15/564,141

(22) PCT Filed: Mar. 29, 2016
(86) PCT No.: PCT/JP2016/060101

§ 371 Date: Oct. 3, 2017

(30) Foreign Application Priority Data
Apr. 8, 2015 (JP) 2015-079621

(51) Int. Cl. G06F 3/0354; G06F 3/044; G06F 3/038; G06F 3/0488

(52) U.S. Cl. CPC G06F 3/03545; G06F 3/044; G06F 3/0346; G06F 3/04883; G06F 3/0383

(57) ABSTRACT

A line accurately corresponding to a natural handwriting motion is rendered on a touch panel. A pen point (11) of a stylus pen (1) is configured of a conductive rubber (12) with elasticity and a conductive fiber cloth (13) with a stretching property wound around the conductive rubber (12).

### TECHNICAL FIELD

The present invention relates to information input pens and, in particular, to an information input pen for inputting information onto a capacitive touch panel.

### BACKGROUND ART

In recent years, a touch panel system which detects a position of an indicator (for example, a finger of a user, a touch pen, or the like) making contact with or approaching a detection surface of a touch panel to accept an instruction from the user has been mounted in many cases on various electronic information equipment such as portable telephones and display devices. In particular, a projection-type capacitive touch panel capable of multitouch has been mounted in many cases on the electronic information equipment.

The projection-type capacitive touch panel system includes a touch panel having a plurality of drive lines provided in parallel to one another along a detection surface and a plurality of sense lines provided in parallel to one another along the detection surface and crossing the plurality of drive lines. By using the fact that the value of a capacitance generated between a drive line and a sense line changes through the indicator making contact with or approaching the detection surface of the touch panel, this touch panel detects the position of the indicator on the detection surface. Therefore, at least a tip portion of the indicator has to be a conductor. In particular, when the indicator is a touch pen, at least a pen point has to be a conductor.

In a conventional touch panel system, with a predetermined electrical signal (drive signal) outputted to each drive line, a predetermined signal (sense signal) corresponding to the value of the capacitance generated by each drive line and each sensor line is obtained from each sensor line. Then, based on the obtained sense signal, an in-plane distribution of changes of the value of capacitance on the detection surface of the touch panel is calculated.

When the touch pen is brought into contact with the touch panel, its pressing force is changed, thereby allowing a contact area of the pen point on the detection surface to be flexibly changed. This allows the user to freely cause a character and graphic to be displayed on the touch panel (refer to Japanese Unexamined Patent Application Publication No. 2014-102788, paragraph 0044).

The above-described conventional touch panel system can detect an in-plane distribution of capacitances in accordance with the contact area of the pen point and calculate a “line thickness” in accordance with the detection result. Software for displaying data inputted by handwriting onto the touch panel in accordance with the line thickness calculated in this manner has been conventionally provided in general as a writing-pressure detection application. Examples of a handwriting obtained when the user uses the touch panel to provide an input onto the detection surface of the touch panel at the time of execution of this application are depicted in FIG. 24.

FIG. 24 is a diagram depicting examples of a handwriting obtained when the user uses the conventional touch panel to provide an input onto the detection surface of the touch panel at the time of execution of the writing-pressure detection application. This drawing depicts a handwriting (a) when the pressing force is weak, a handwriting (b) when the pressing force is strong, and a handwriting (c) when the pressing force is further strong. It can be found from this drawing that a difference in writing pressure (pressing force) when the touch pen is used is represented as a difference in thickness of a line rendered on the touch panel.

As examples of the conventional technology in which the contact area of the pen point of the touch pen can be changed in accordance with the pressing force, the following inventions are respectively disclosed in PTLs 1 to 5.

PTL 1: A brush type input device in which, in a writing brush tube body and a simulation writing brush top body installed at a joint at the top end of the writing brush tube body, the simulation writing brush top body is configured of a plurality of multi-stage cylindrical bodies, the cylindrical body whose diameter is small is stored in a cylindrical body whose diameter is large so as to be slidable in an axial direction, and has a nested structure having fall preventing structures while each cylindrical body is maintained in the same axis, the cylindrical bodies other than the cylindrical body configuring at least the hip of the simulation writing brush top body are energized outward by energizing means, and the energizing force applied to each energized cylindrical body is set to be gradually made strong from a point side.

PTL 2: An input pen in which a pen point member having a porous base material and a material at least partially exposed to a surface of the base material and having a rubber material coupled to the base material inside the base material is attached and fixed to an end of a pen main body.

PTL 3: A capacitive input pen including a pen main body to be used by a user and having a tip part of this pen main body supporting a conductive pen point, in which the pen point is formed of a plurality of conductive fibers into a brush shape.

PTL 4: An input pen for a capacitive coordinate input pad, the input pen including a conductive pen main body to be held by a hand of a user and a conductive pen point electrically conducted to the pen main body and capable of inputting coordinate information onto the capacitive coordinate input pad, in which the pen point is configured of a conductive rubber.

PTL 5: An input device including a conductive unit formed of a conductive material into a pen barrel shape and changing a capacitance with respect to a touch panel to specify three-dimensional coordinates on the touch panel and a tip part formed of a non-conductive material at one end of the conductive unit so as to be narrower than the conductive unit and making contact with the touch panel when the conductive unit specifies the three-dimensional coordinates.

### CITATION LIST

### Patent Literature

PTL 1: Japanese Unexamined Patent Application Publication No. 2009-251704 (published on Oct. 29, 2009)
PTL 2: Japanese Unexamined Patent Application Publication No. 2013-186803 (published on Sep. 19, 2013)
PTL 3: Japanese Unexamined Patent Application Publication No. 2010-39610 (published on Feb. 18, 2010)
PTL 4: Japanese Unexamined Patent Application Publication No. 10-161795 (published on Jun. 19, 1998)
PTL 5: Japanese Unexamined Patent Application Publication No. 2014-142676 (published on Aug. 7, 2014)

### SUMMARY OF INVENTION

### Technical Problem

The above-described PTLs 1 to 5 have the following problems. PTL 1: The change in thickness of the pen point in accordance with the pressing force is merely on the order of several stages at the most. Moreover, the change in thickness of the pen point in accordance with the pressing force is not monotonously increased.

PTL 2: It takes large efforts and costs to mix a fibrous material and the rubber material. Also in this literature, the fibrous material is used to enhance the stiffness of the pen point member, and the thickness of the pen point member having this fibrous material thus fails to be sufficiently changed in accordance with the pressing force.

PTL 3: This technology assumes only an operation on a touch panel which supports a musical equipment application, the operation for “touching and pressing” the touch panel. Therefore, the width of the path fails to be controlled by changing the thickness of the pen point on the touch panel. Moreover, the pen point of the touch pen is formed only of conductive fiber, and the thickness of the pen point thus fails to be sufficiently greatly changed in accordance with the pressing force.

PTL 4: The pen point of the touch pen is formed only of a conductive rubber, and the change in thickness of the pen point in accordance with the pressing force is thus insufficient. Moreover, a high coefficient of friction of the conductive rubber degrades sliding of the pen tip, thereby placing stress on the user at the time of using the touch pen.

PTL 5: The pen point of the touch pen is formed only of a non-conductive material, and the change in thickness of the pen point in accordance with the pressing force is thus insufficient.

Examples of a path of a line inputted to the touch pen by using each touch panel disclosed in these literatures are depicted in FIG. 25. FIG. 25 is a diagram depicting examples of a path of a line inputted to the touch pen by using each touch panel according to the conventional technology. As depicted in (a) and (b) of this drawing, when the writing pressure (pressing force) is abruptly changed during an input of a line using the touch pen of the conventional technology, the thickness of the line inputted onto the touch panel abruptly changes. As a result, smoothness is lost from the path (handwriting) of the rendered line.

The present invention was made to resolve the above-described problems, and an object of the present invention is to provide an information input pen capable of rendering a line accurately corresponding to a natural handwriting motion on a touch panel and an information input system including the information input pen.

### Solution to Problem

To resolve the above-described problems, an information input pen according to one mode of the present invention provides an information input pen for inputting information onto a capacitive touch panel, the information input pen including a pen main body and a conductive pen point configured of a conductive rubber and a conductive fiber cloth wound around the conductive rubber, wherein the pen main body is non-conductive, the information input pen further includes a conductive unit electrically connected to the pen point and diagonally arranged with respect to a length direction of the pen main body, and when the pen point makes contact with or approaches an input surface of the touch panel, a tilt angle of the conductive unit in the length direction with respect to the input surface of the touch panel is a predetermined angle at which a difference between a contact position or an approach position of the pen point on the input surface and a barycenter position in a distribution of magnitudes of change in capacitance occurring by the pen point making contact with or approaching the input surface is uniform irrespective of a location on the input surface.

To resolve the above-described problems, an information input pen according to one mode of the present invention provides an information input pen for inputting information onto a capacitive touch panel, the information input pen comprising: a pen main body; and a conductive pen point configured of a conductive rubber and a conductive fiber cloth wound around the conductive rubber, wherein the pen main body is non-conductive, the information input pen further includes a conductive unit electrically connected to the pen point, a movable unit which moves the conductive unit so that, when a contact or an approach of the information input pen is not detected by the touch panel, the tilt angle of the conductive unit in the length direction with respect to the input surface of the touch panel is the predetermined angle at which the difference between the contact position or the approach position of the pen point on the input surface and the barycenter position in the distribution of the magnitudes of change in capacitance occurring by the pen point making contact with or approaching the input surface is uniform irrespective of the location on the input surface, and a fixing unit which fixes the conductive unit when the approach of the information input pen is detected by the touch panel.

To resolve the above-described problems, an information input pen according to one mode of the present invention provides an information input pen for inputting information onto a capacitive touch panel, the information input pen comprising: a pen main body; and a conductive pen point configured of a conductive rubber and a conductive fiber cloth wound around the conductive rubber, wherein the pen main body is non-conductive, the information input pen further includes a conductive unit electrically connected to the pen point, and a movable unit which moves the conductive unit so that, when a notification that the distribution of the capacitances measured by the touch panel has a certain bias or more is received from the touch panel, the tilt angle of the conductive unit in the length direction with respect to the input surface of the touch panel is made closer to the predetermined angle at which the difference between the contact position or the approach position of the pen point on the input surface and the barycenter position in the distribution is uniform irrespective of the location on the input surface.

### Advantageous Effects of Invention

According to one mode of the present invention, an effect can be achieved in which a line accurately corresponding to a natural handwriting motion can be rendered on the touch panel.

### BRIEF DESCRIPTION OF DRAWINGS

FIG. 1 is a perspective view depicting the structure of main parts of a touch input system (information input system) according to a first embodiment of the present invention.

FIG. 2 is a block depicting the structure of main parts of a touch panel according to the first embodiment of the present invention.

FIG. 3 is a diagram depicting the structure of main parts of a stylus pen according to the first embodiment of the present invention.

FIG. 4 is a diagram depicting diameters (magnitudes) of a contact surface of a pen point and distributions of magnitudes of changes in capacitance in the touch panel according to the first embodiment of the present invention.

FIG. 5 is a diagram depicting a relation between push lengths of the pen point and diameters of the contact surface of the pen point, according to the first embodiment of the present invention.

FIG. 6 is a diagram depicting a relation between loads given by a user on the stylus pen by pressing and amounts of change in thickness of the pen point, in the first embodiment of the present invention.

(a) of FIG. 7 is a diagram depicting characters written by using a stylus pen with a hard pen point according to conventional technology, and (b) of FIG. 7 is a diagram depicting characters written by using the stylus pen with the pen point with both elasticity and a stretching property according to the first embodiment of the present invention.

FIG. 8 is a perspective view depicting the structure of main parts of a touch input system according to a second embodiment of the present invention.

FIG. 9 is a block depicting the structure of main parts of a touch panel configuring an information input system according to the second embodiment of the present invention.

FIG. 10 is a diagram depicting the structure of main parts of a stylus pen configuring the information input system according to the second embodiment of the present invention.

FIG. 11 is a diagram depicting an example of a relation between tilt angles of a pen main body and tilt angles of a conductive unit with respect to an input surface of the touch panel, in the second embodiment of the present invention.

FIG. 12 is a diagram describing a problem when the conventional stylus pen is tilted at 30° with respect to the input surface of the touch panel.

FIG. 13 is a diagram describing a problem when the conventional stylus pen is tilted at 45° with respect to the input surface of the touch panel.

FIG. 14 is a diagram describing a problem when the stylus pen according to the second embodiment of the present invention is tilted at 30° with respect to the input surface of the touch panel.

FIG. 15 is a diagram depicting examples (photographs) of implementation of the stylus pen according to the second embodiment of the present invention.

FIG. 16 is a diagram depicting a relation between tilts of the conventional stylus pen and misalignment of a barycenter position with respect to a mesh space of the touch panel.

FIG. 17 is a perspective view depicting the structure of main parts of a touch input system according to a third embodiment of the present invention.

FIG. 18 is a diagram depicting the structure of main parts of a stylus pen and a touch panel configuring the touch input system according to the third embodiment of the present invention.

FIG. 19 is a diagram depicting a state of the stylus pen before detected by the touch panel in the third embodiment of the present invention.

FIG. 20 is a diagram depicting a state of the stylus pen after detected by the touch panel in the third embodiment of the present invention.

FIG. 21 is a perspective view depicting the structure of main parts of a touch input system according to a fourth embodiment of the present invention.

FIG. 22 is a diagram depicting the structure of main parts of a stylus pen and a touch panel configuring the touch input system according to the fourth embodiment of the present invention.

FIG. 23 is a diagram depicting a state in which the tilt of a conductive unit is adjusted in accordance with a bias of a distribution of magnitudes of change in capacitance, in the stylus pen according to the fourth embodiment of the present invention.

FIG. 24 is a diagram depicting examples of a handwriting obtained when a user uses a conventional touch panel to provide an input onto a detection surface of the touch panel at the time of execution of a writing-pressure detection application.

FIG. 25 is a diagram depicting examples of a path of a line inputted to a touch pen by using each touch panel according to the conventional technology.

### DESCRIPTION OF EMBODIMENTS

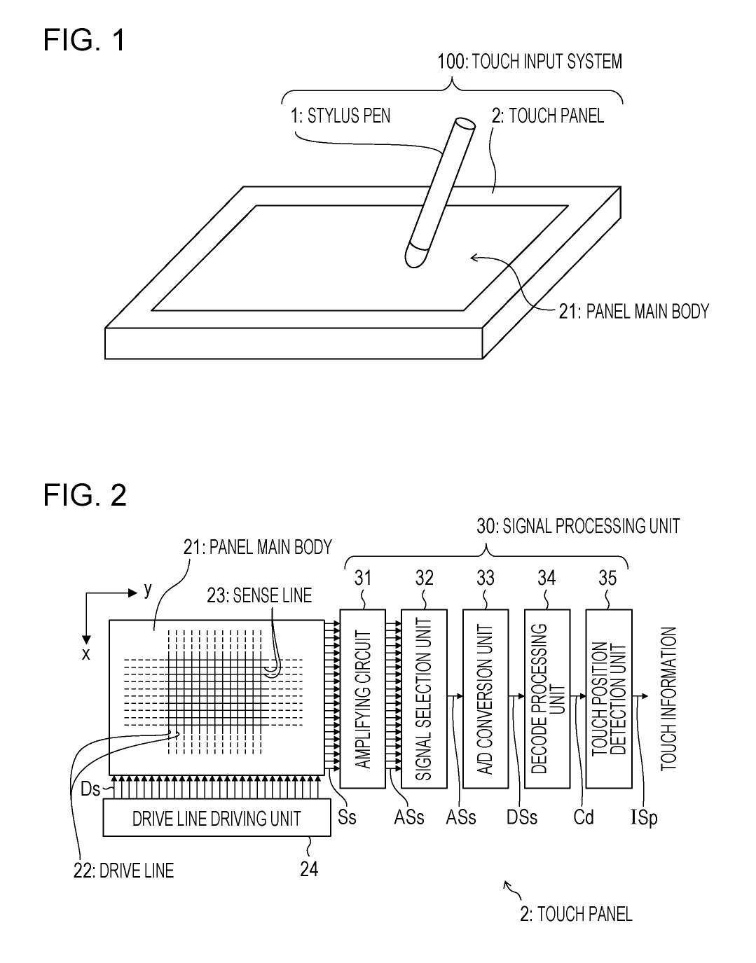

A first embodiment according to the present invention is described below based on FIG. 1 to FIG. 7.

### (Structure of Touch Input System 100)

FIG. 1 is a perspective view depicting the structure of main parts of a touch input system 100 (information input system) according to the present embodiment. As depicted in this drawing, the touch input system 100 is configured of a stylus pen 1 (information input pen) and a capacitive touch panel 2. The user performs a touch input (touch operation) on the touch panel 2 by causing the stylus pen 1 to make contact with or approach an input surface of the touch panel 2. The touch panel 2 is integrated with a display device (not depicted), and the input surface of the touch panel 2 is arranged so as to be superposed on a display surface of the display device.

In an information input device with the touch panel 2 and the display device integrated together, the user can input information by touching a region on the display surface of the display device where an object, such as an operation button, is displayed. The user can also input a line and character by stroking the input surface of the touch panel 2 with the stylus pen 1.

FIG. 2 is a block depicting the structure of main parts of the touch panel 2 according to the present embodiment. As depicted in this drawing, the touch panel 2 includes a panel main body 21 having plurality of drive lines 22 and a plurality of sense lines 23, a drive line driving unit 24 which applies drive signals Ds to the drive lines 22 of the panel main body 21, and a signal processing unit 30 which receives sense signals Ss occurring by application of these drive signals Ds from the sense lines 23 and generates touch information ISp for the sense signals Ss. Although not particularly depicted, the input surface of the panel main body 21 is provided with a transparent glass cover. When the stylus pen 1 is used, its pen point 11 makes contact with this glass cover.

The signal processing unit 30 includes an amplifying circuit 31, a signal selection unit 32, an A/D conversion unit 33, a decode processing unit 34, and a touch position detection unit 35. The amplifying circuit 31 amplifies the sense signals Ss from the plurality of sense lines 23. The signal selection unit 32 sequentially selects amplified sense signals ASs, and outputs the selected amplified sense signal ASs. The A/D conversion unit 33 converts the outputted amplified sense signal ASs to a digital signal DSs. The decode processing unit 34 decodes the obtained digital signal DSs by using a conversion signal for decoding based on a sequence signal for use in generating the drive signals Ds, and obtains a signal strength Cd equivalent to the magnitude of change in capacitance at each intersection point part between the drive line 22 and the sense line 23 on the panel main body 21. The touch position detection unit 35 calculates a distribution of magnitudes of change in capacitance in the panel main body 21 based on this signal strength Cd, and generates the touch information ISp indicating a touch position and a touch range by the user on the panel main body 21 based on a barycenter position of the distribution and a spread of the distribution, thereby detecting a touch position and a touch range on the input surface.

On the touch panel 2, the plurality of drive lines 22 arranged in parallel to one another and the sense lines 23 arranged in parallel to one another are arranged so as to three-dimensionally cross each other. The plurality of drive lines 22 and the plurality of sense lines 23 form an electrode pattern on a matrix. At least an intersection point between each drive line 22 and each sense line 23 is insulated. At each intersection point, a capacitance occurs between the drive line 22 and the sense line 23. When a grounded conductive indicator (finger or stylus pen 1) makes contact with or approaches the input surface of the touch panel 2, a charge between the drive line 22 and the sense line 23 near the indicator moves to a ground direction through the indicator. This decreases the capacitance near the indicator. By measuring the magnitude of this change in capacitance, the touch panel 2 detects a touch position (contact position) or approach position of the indicator on the input surface. In the present embodiment, the touch panel 2 measures a distribution of magnitudes of change in capacitance and calculates a barycenter position of the distribution and a spread of the distribution, thereby also being capable of detecting a touch position or approach position at a location other than the intersection points and the range thereof.

### (Structure of Stylus Pen 1)

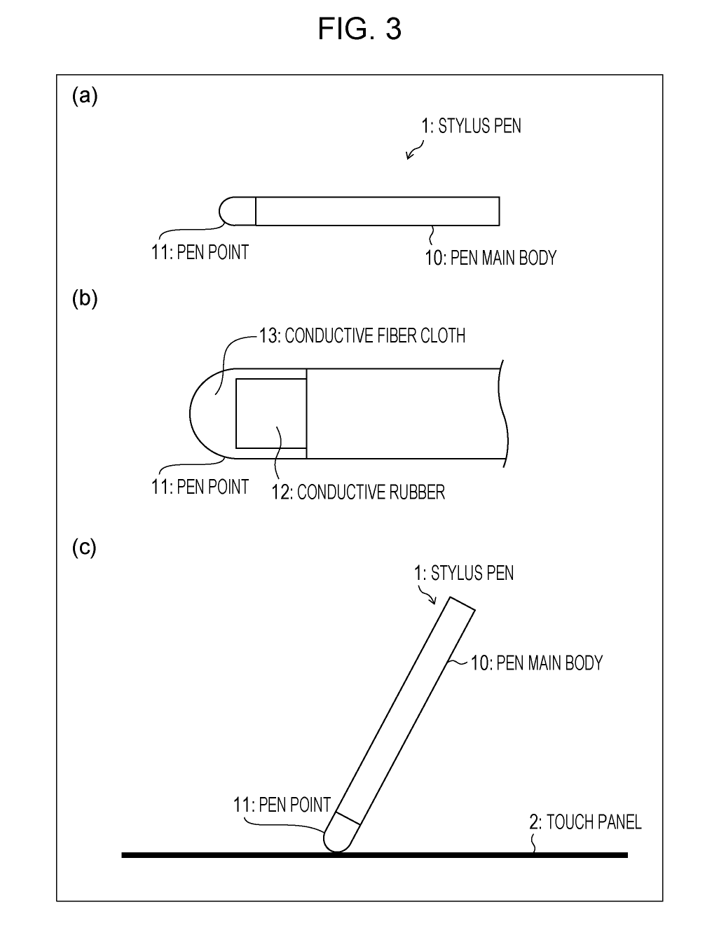

FIG. 3 depicts the structure of main parts of the stylus pen 1 according to the present embodiment. As depicted in (a) of FIG. 3, the stylus pen 1 includes a pen main body 10 and the pen point 11. The pen main body 10 and the pen point 11 are configured of a conductive material. As depicted in (b) of FIG. 3, the pen point 11 is configured of a conductive rubber 12 with elasticity and a conductive fiber cloth 13 with a stretching property.

The conductive rubber 12 is present inside the pen point 11, and the conductive fiber cloth 13 is wound around the periphery of the conductive rubber 12. In this manner, the pen point 11 has a dual structure with the conductive rubber 12 and the conductive fiber cloth 13. With the elasticity of the conductive rubber 12 and the stretching property of the conductive fiber cloth 13, a shape change (diameter spread) of the pen point 11 by pushing can be more increased.

In an example depicted in (b) of FIG. 3, the shape of the conductive rubber 12 is a square. However, the shape of the conductive rubber 12 is not limited to this and, for example, may be a circular shape or a semispherical shape on a tip side of the stylus pen 1. In these cases, the conductive fiber cloth 13 has to be wound around the conductive rubber 12 so as to keep the semispherical shape on the tip side of the stylus pen 1 in the conductive rubber 12.

With the conductive fiber cloth 13 covered with the conductive rubber 12, not the conductive rubber 12 but the conductive fiber cloth 13 makes contact with the input surface of the touch panel 2 when the stylus pen 1 is used. The conductive fiber cloth 13 has a sufficiently low coefficient of friction compared with that of the conductive rubber 12. Thus, even if the conductive rubber 12 is present inside the pen point 11, the pen point 11 can smoothly slide over the input surface when the stylus pen 1 is used. Therefore, the stylus pen 1 can provide comfortable operability to the user.

As in the above-described PTL 3, the method of manufacturing a pen point by combining conductive fiber with a conductive rubber has to take enormous efforts and costs in manufacture. On the other hand, as in the first embodiment of the present invention, the method of manufacturing the pen point 11 by winding the conductive fiber cloth 13 around the conductive rubber 12 can minimize efforts and costs for manufacture.

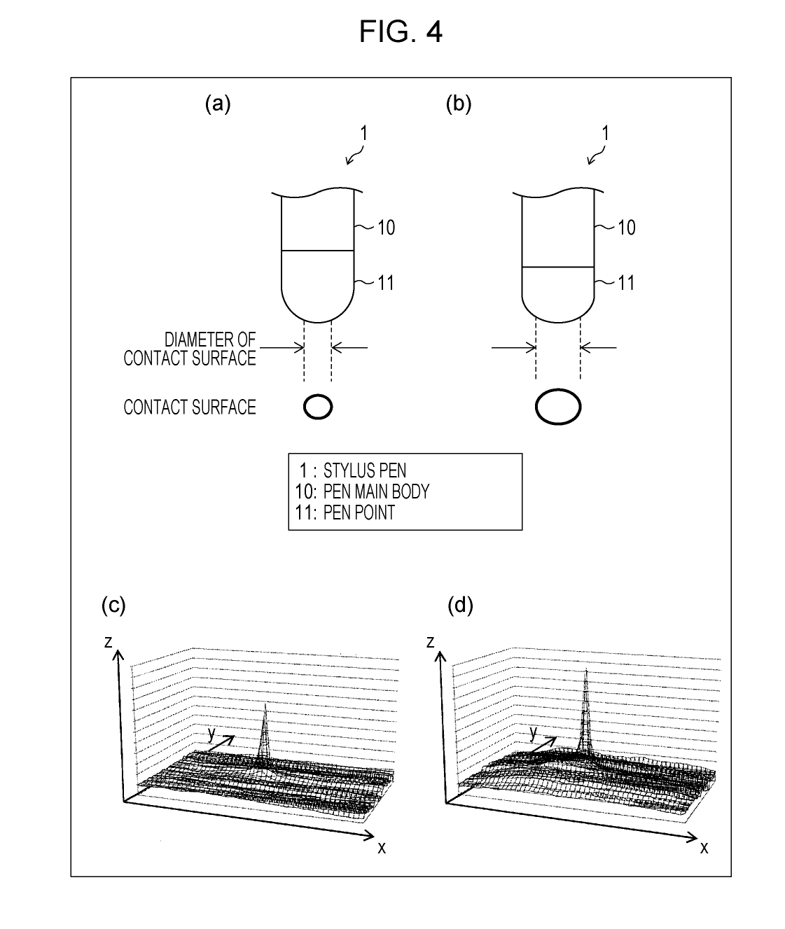

As depicted in (c) of FIG. 3, the stylus pen 1 is tilted at a certain angle with respect to the input surface of the touch panel 2 at the time of use. By the user giving a load onto the stylus pen 1 to push (press) the pen point 11 of the stylus pen 1 onto the input surface of the touch panel 2, the shape of the pen point 11 is changed in accordance with the pressing force exerted onto the pen point 11 at that time. Furthermore, in accordance with this shape change, the distribution of magnitude of change in capacitance in the touch panel 2 is also changed. These points are described below with reference to FIG. 4.

### (Example of Distribution of Capacitances)

FIG. 4 is a diagram depicting diameters (magnitudes) of a contact surface of the pen point 11 and distributions of magnitudes of changes in capacitance in the touch panel 2, according to the present embodiment. (a) and (b) of FIG. 4 depict a difference in diameter of the pen point 11 depending on the strength of the pressing force. (a) of FIG. 4 depicts the diameter of the pen point 11 when the pressing force is weak. (b) of FIG. 4 depicts the diameter of the pen point 11 when the pressing force is strong. As depicted in these drawings, as the pressing force is larger, the diameter of the pen point 11 is increased more.

Distributions of capacitances in the touch panel 2 when the pen point 11 in the states of (a) and (b) of FIG. 4 makes contact with the touch panel 2 are respectively depicted in (c) and (d) of FIG. 4. As can be seen from these drawings, as the contact surface of the pen point 11 is larger, an in-plane distribution of capacitances is spread more and the capacitance value is larger. The touch panel 2 detects an in-plane distribution of capacitances as depicted in (c) or (d) of FIG. 4 to calculate a thickness of a line in accordance with the detection result.

### (Resolution of Change)

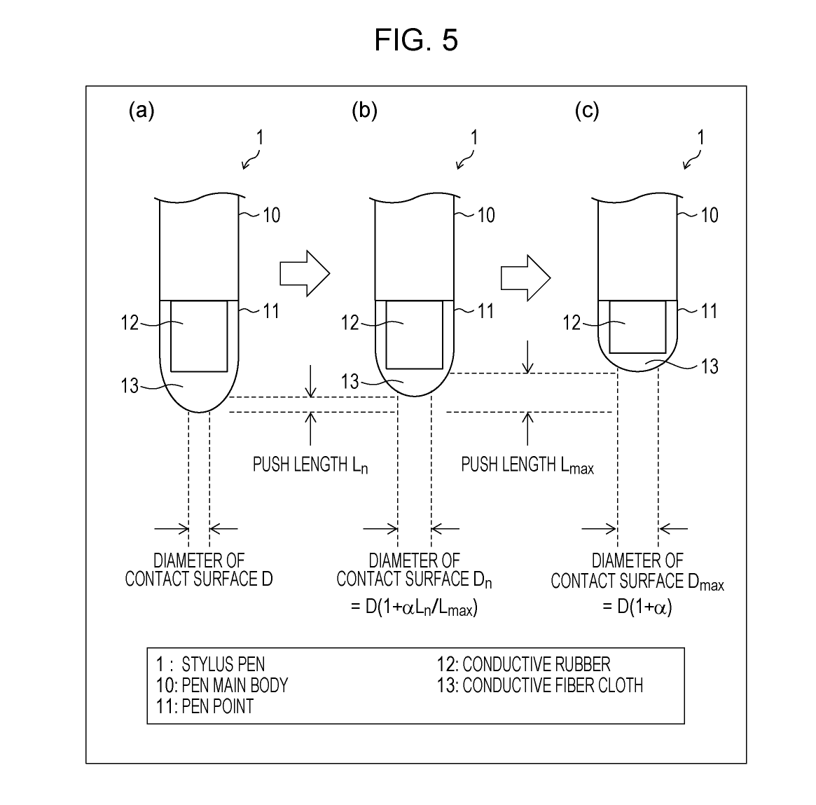

FIG. 5 is a diagram depicting a relation between push lengths of the pen point 11 and diameters of the contact surface of the pen point 11 in the present embodiment. (a) of FIG. 5 depicts a diameter D of the pen point 11 when the stylus pen 1 is not pressed. In the present embodiment, the diameter D of the pen point 11 in this case is assumed to be 3 mm. Also, the conductive fiber cloth 13 wound at the pen point 11 around the outside of the conductive rubber 12 is assumed to have a thickness of 0.25 mm.

(b) of FIG. 5 depicts a diameter Dₙ of the pen point 11 when the stylus pen 1 is pressed and the pen point 11 is pushed into a pen main body 10 side by a push length Lₙ. Dₙ=D(1+α(Lₙ/L_{Max})) holds. Here, L_{Max} is a maximum possible push length of the contact surface of the pen point 11. α is a predetermined coefficient, and α=0.2 holds in the present embodiment. (b) of FIG. 5 depicts a case in which Lₙ=L_{Max}/2 holds. In this stage, with the conductive fiber cloth 13 outside the conductive rubber 12 being spread, the diameter of the pen point 11 is increased in accordance with the pressing force.

(c) of FIG. 5 depicts a diameter D_{Max} of the pen point 11 when the stylus pen 1 is pressed and the pen point 11 is pushed into the pen main body 10 side by a maximum push length L_{Max}. D_{Max}=D(1+α) holds. When the push length is the maximum push length L_{Max}, the maximum diameter D_{Max} of the pen point 11 is achieved. In this stage, in addition to the conductive fiber cloth 13 on the periphery of the conductive rubber 12, the diameter of the conductive rubber 12 is also changed in accordance with the load, thereby achieving the maximum diameter D_{Max}.

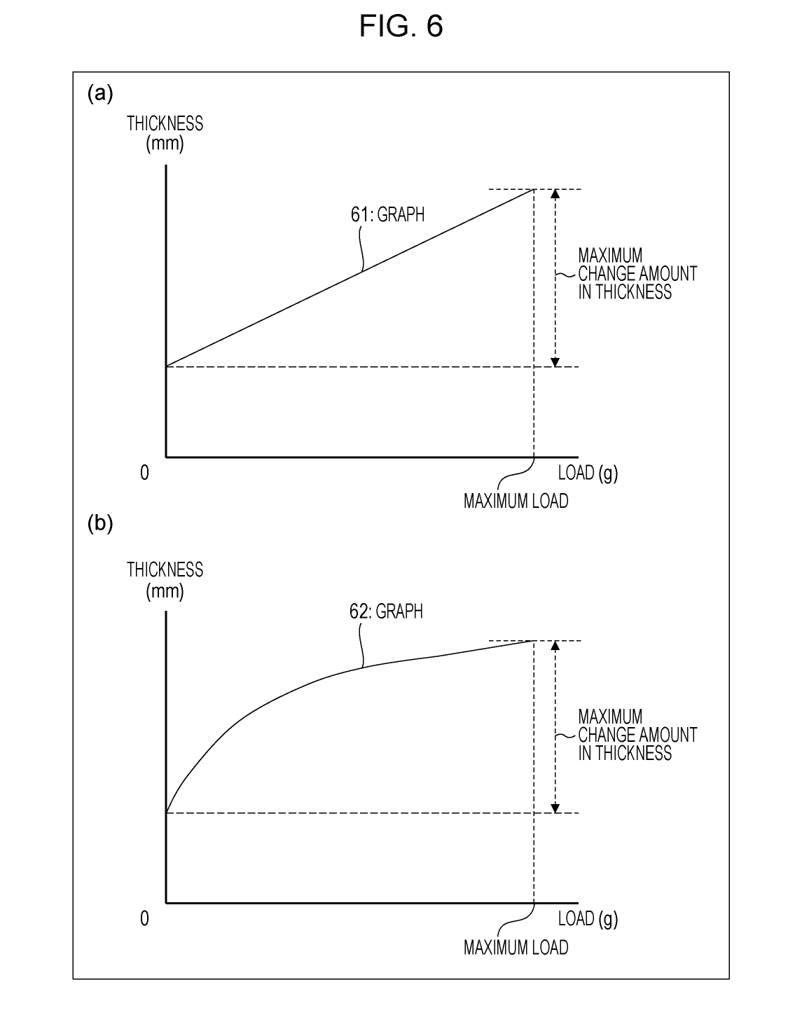

FIG. 6 is a diagram depicting a relation between loads given by the user to the stylus pen 1 by pressing and amounts of change in thickness of the pen point 11 in the present embodiment. In both (a) and (b) of FIG. 6, it is depicted that the change of the pen point 11 with respect to the change of the load is monotonously increased. A graph 61 depicted in (a) of FIG. 6 depicts that the change in thickness of the pen point 11 with respect to the change of the load has a linear relation. On the other hand, a graph 62 depicted in (b) of FIG. 6 depicts that the change in thickness of the pen point 11 with respect to the change of the load has a curved relation. The stylus pen 1 preferably includes the pen point 11 having an ideal linear relation depicted in (a) of FIG. 6.

Since α=0.2 holds, when the maximum load is given to the stylus pen 1, the thickness of the pen point 11 is increased by 20% more than the original thickness (that is, when no load is given). For example, when the maximum load of 200 g is given to the stylus pen 1, the thickness of the pen point 11 is increased by up to 0.6 mm (=3 mm×0.20).

In general, it has been known that the maximum load by human hand is 300 g to 400 g. In the present embodiment, the resolution with respect to the amount of change in thickness of the pen point 11 is 0.05% of the pitch of sensors provided at the intersection points of the drive lines 22 and the sense lines 23. For example, when the sensor pitch is 4 mm, the resolution of change in thickness of the pen point 11 is 0.002 mm/g. In this case, the touch panel 2 can accurately calculate a difference in thickness (that is, thickness of a line) of the pen point 11 in units of 0.002 mm.

### (Line Comparison)

(a) of FIG. 7 is a diagram depicting characters written by using a stylus pen with a hard pen point according to the conventional technology. (b) of FIG. 7 is a diagram depicting characters written by using the stylus pen 1 with the pen point 11 with both elasticity and a stretching property according to the present embodiment.

The pen point of the stylus pen according to the conventional technology is hard, and the thickness of the pen point thus does not change even if the user gives a load to the stylus pen. Therefore, characters written by the user using the stylus pen according to the conventional technology while changing the load have a uniform line thickness at all times, as depicted in (a) of FIG. 7. As a result, as indicated by arrows in (a) of FIG. 7, a “sweep” of each written character is not represented at all.

On the other hand, the pen point 11 of the stylus pen 1 according to the first embodiment of the present invention has both flexibility of the conductive rubber 12 and the stretching property of the conductive fiber cloth 13, and is also very soft. Therefore, when the user uses the stylus pen 1 according to the first embodiment of the present invention to write a character on the input surface of the touch panel 2 while changing the load given to the stylus pen 1, the diameter (thickness) of the contact surface of the pen point 11 changes as appropriate in accordance with the change in pushing strength (that is, pressing force) to the pen point 11. As a result, as indicated by arrows in (b) of FIG. 7, a “sweep” of the rendered line is accurately represented as intended by the user on the touch panel 2. That is, by using the stylus pen 1, the user can render a line accurately corresponding to a natural handwriting motion using a real brush on the touch panel 2.

### Second Embodiment

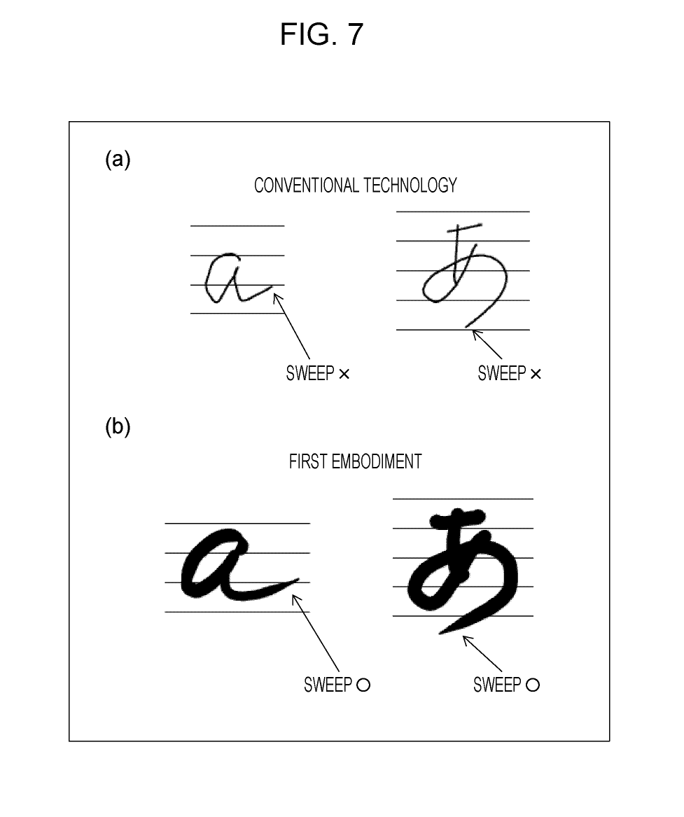

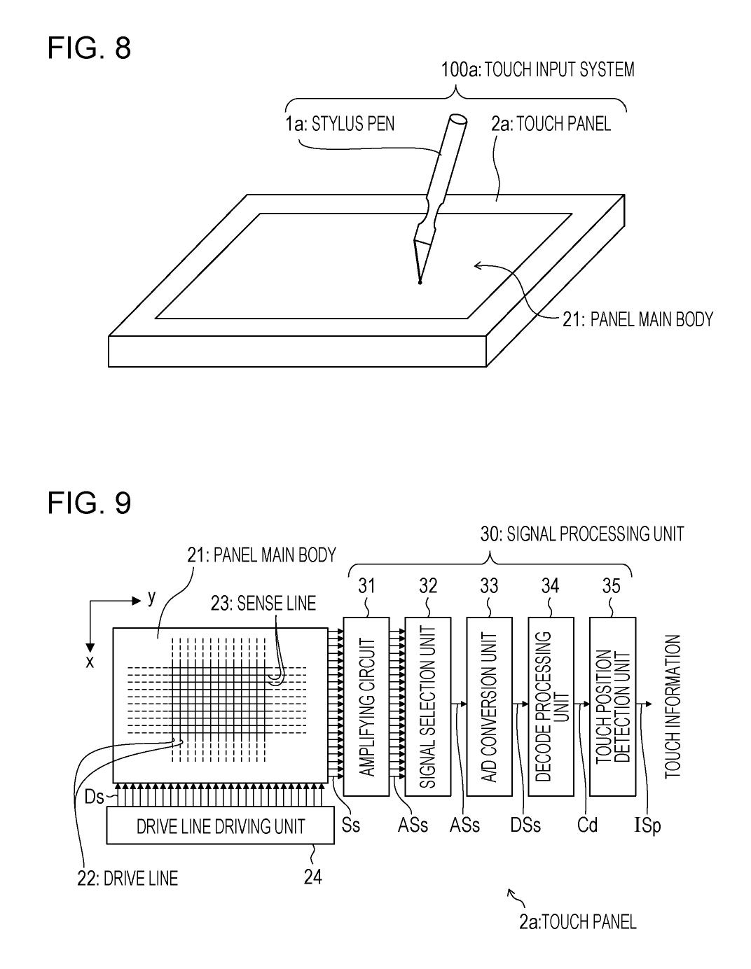

A second embodiment according to the present invention is described below based on FIG. 8 to FIG. 16.

### (Structure of Touch Input System 100a)

FIG. 8 is a perspective view depicting the structure of main parts of a touch input system 100a (information input system) according to the present embodiment. As depicted in this drawing, the touch input system 100a is configured of a stylus pen 1a (information input pen) and a capacitive touch panel 2a.

FIG. 9 is a block depicting the structure of main parts of the touch panel 2a according to the present embodiment. As depicted in this drawing, the structure and function of the touch panel 2a according to the present embodiment are basically identical to those of the touch panel 2a according to the first embodiment. Therefore, detailed description regarding the touch panel 2a is omitted.

### (Structure of Stylus Pen 1a)

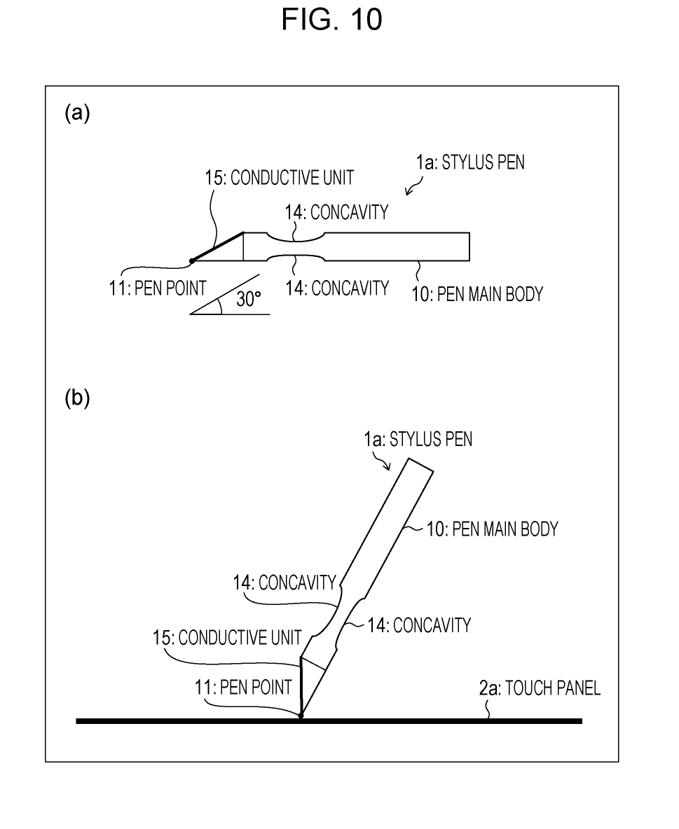

FIG. 10 is a diagram depicting the structure of main part of the stylus pen 1a. As depicted in (a) of FIG. 10, the stylus pen 1a includes the pen main body 10, the pen point 11, and a conductive unit 15. The pen main body 10 of the present embodiment is configured of a non-conductive material. On the other hand, the pen point 11 and the conductive unit 15 are both configured of a conductive material.

Although not particularly depicted, as with the first embodiment of the present invention, the pen point 11 according to the present embodiment is configured of the conductive rubber 12 and the conductive fiber cloth 13 wound around the periphery of the conductive rubber 12. This makes the thickness of the pen point 11 change with a resolution of at least 1024 steps in accordance with the load given to the stylus pen 1a at the time of use. Therefore, when the user uses the stylus pen 1a to write a character on the touch panel 2a, the thickness of a line being rendered flexibly changes in accordance with the load.

On the pen main body 10, a tilted surface tilted at 30° with respect to a length direction of the stylus pen 1a is formed, and the conductive unit 15 is formed on this tilted surface. With this, the conductive unit 15 is diagonally arranged with respect to the length direction of the pen main body 10 and, more specifically, is tilted at 30° with respect the length direction of the pen main body 10. In other words, the length direction of the stylus pen 1a and the length direction of the conductive unit 15 form an angle of 30°. The conductive unit 15 has one end electrically connected to the pen point 11.

At a portion in the pen main body 10 where the stylus pen 1a is held, a plurality of concavities 14 are formed. These concavities 14 have a shape fitting to the fingers of the users when the user holds the stylus pen 1a. When the user naturally holds the stylus pen 1a so that his or her fingers fit in the plurality of concavities 14, the conductive unit 15 comes on the upper side (front side) of the stylus pen 1a.

A part of the portion to be held by the user in the stylus pen 1a is provided with a conductive portion not depicted. By electrically connecting this conductive portion and the pen point 11, the conductive unit 15 grounds the stylus pen 1a via the human body and also serves as a lead for moving the capacitance in the touch panel 2a to a ground direction. This conductive portion is desired to be provided to the concavities 14.

In the present embodiment, unlike the conventional example, the pen point 11 is made small, and the change in capacitance appearing on the touch panel 2a is thus approximately caused by the conductive portion present at the tip of the stylus pen 1a. In the case of the present embodiment, the conductor present at the tip of the stylus pen 1a corresponds to the pen point 11 and the conductive unit 15. Since the length of the conductive unit 15 is sufficiently longer than the pen point 11, most of influences given to the distribution of the measured magnitudes of change in capacitance is occupied by influences based on the tilt angle of the conductive unit 15 with respect to the input surface.

As depicted in (a) of FIG. 10, the stylus pen 1a is tilted at a certain angle with respect to the input surface of the touch panel 2a at the time of use. Since the conductive unit 15 is tilted at 30° with respect to the length direction of the stylus pen 1a, the tilt angle of the pen main body 10 and the tilt angle of the conductive unit 15 with reference to the input surface are different from each other.

### (Relation Between Tilt Angles)

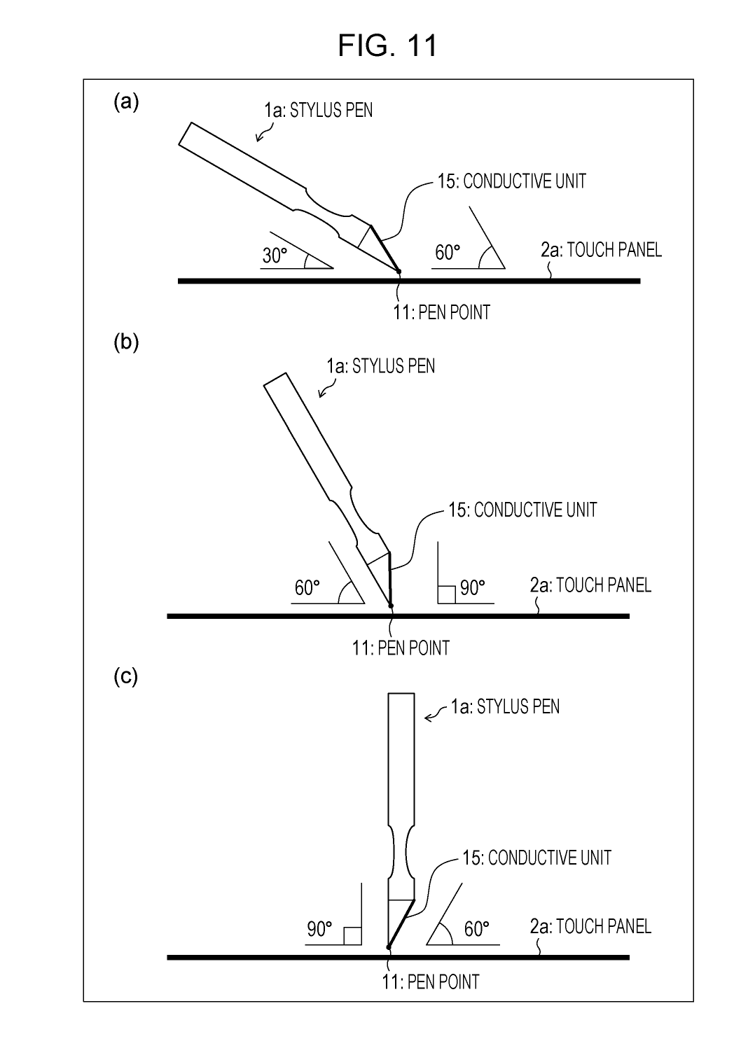

FIG. 11 is a diagram depicting an example of a relation between tilt angles of the pen main body 10 and tilt angles of the conductive unit 15 with respect to the input surface.

In (a) of FIG. 11, the stylus pen 1a is tilted so that the tilt angle of the pen main body 10 with respect to the input surface is 30°. Here, the tilt angle of the conductive unit 15 with respect to the input surface is 60°. That is, the conductive unit 15 is tilted at 30° with respect to a direction perpendicular to the input surface.

In (b) of FIG. 11, the stylus pen 1a is tilted so that the tilt angle of the pen main body 10 with respect to the input surface is 60°. Here, the tilt angle of the conductive unit 15 with respect to the input surface is 90°. That is, the conductive unit 15 is not tilted at all with respect to the direction perpendicular to the input surface and, in other words, stands upright with respect to the input surface.

In (c) of FIG. 11, the stylus pen 1a stands upright so that the tilt angle of the pen main body 10 with respect to the input surface is 90°. Here, the tilt angle of the conductive unit 15 with respect to the input surface is 60°. Therefore, the conductive unit 15 is tilted at 30° with respect to the direction perpendicular to the input surface.

As depicted in (a) to (c) of FIG. 11, in the stylus pen 1a, when the pen point 11 makes contact with the input surface of the touch panel 2a, the tilt angle of the conductive unit 15 with respect to the input surface is 60° to 90° (equal to or larger than 60° and equal to or smaller than 90°) in a range where the tilt angle of the pen main body 10 with respect to the input surface is 30° to 90°. In other words, the tilt angle of the conductive unit 15 with respect to the direction perpendicular to the input surface is 0° to 30°. When the conductive unit 15 is tilted at an angle within these ranges, although will be described in detail further below, a difference between an actual touch position (or approach position) of the pen point 11 with respect to the input surface and a barycenter position in the distribution of the measured magnitudes of change in capacitance is uniform irrespective of the location on the input surface. This can reduce influences of the conductive unit 15 on the distribution of magnitudes of change in capacitance, and variability of the detected touch position (or approach position) can thus be reduced.

Also as depicted in (a) of FIG. 11, even if the tilt angle of the stylus pen 1a with respect to the direction perpendicular to the input surface is increased, the tilt angle of the conductive unit 15 with respect to the direction perpendicular to the input surface is as small as 30°. Therefore, even if the stylus pen 1a is greatly tilted with respect to the direction perpendicular to the input surface, variability of the detected touch position can be reduced.

Furthermore, since the stylus pen 1a is configured in consideration of the influences of the conductive unit 15 on the distribution of the measured magnitudes of change in capacitance, unlike the stylus pen disclosed in PTL 1, the pen point 11 does not have to be increased to decrease the influences. Therefore, even if the pen point 11 is sufficiently small, variability of the detected touch detection when the stylus pen 1a is greatly tilted can be reduced.

### (Path Comparison)

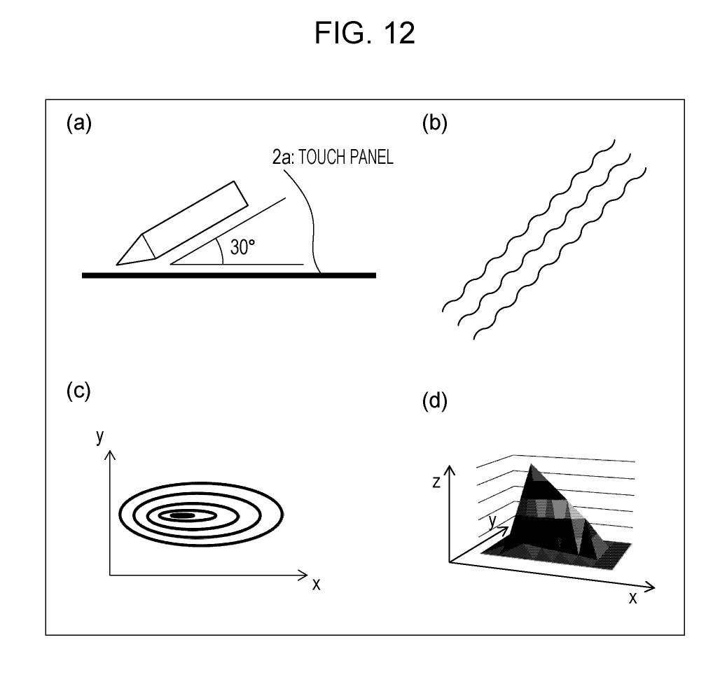

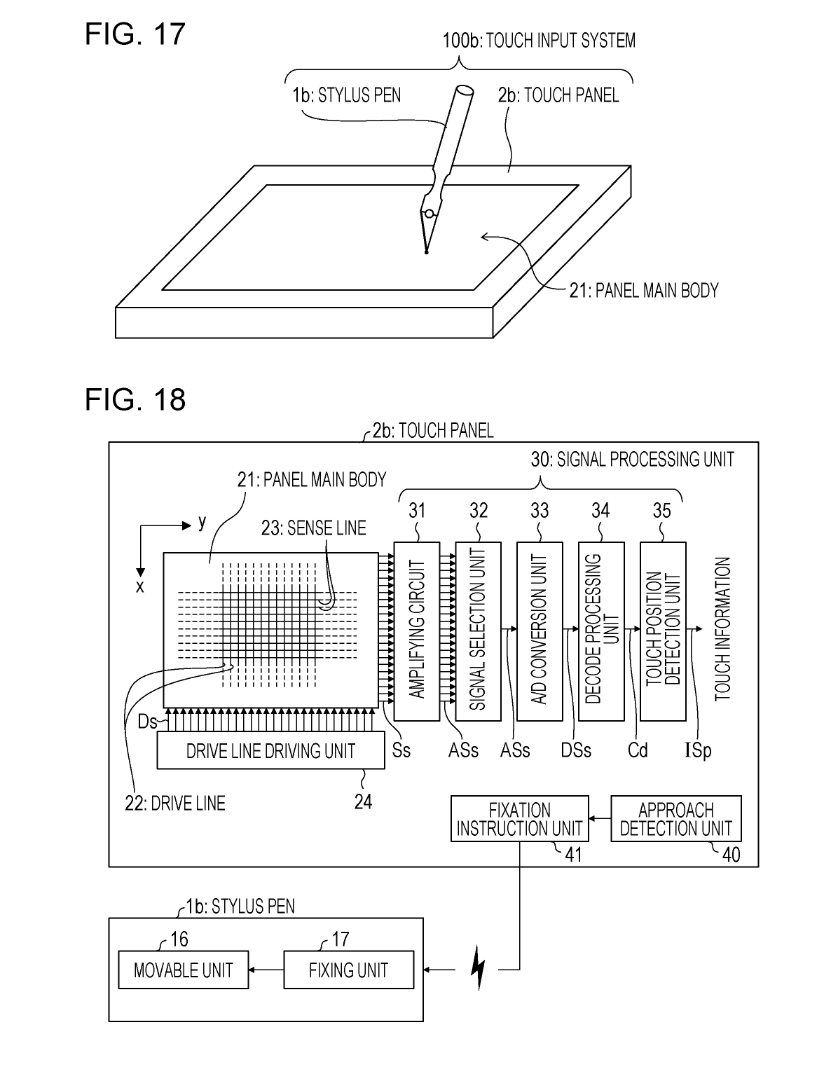

When a conventional stylus pen is greatly tilted with respect to the perpendicular direction of the input surface, a problem occurs in which the path of the pen point on the touch panel 2a becomes jagged. On the other hand, such a problem does not occur in the stylus pen 1a according to the present embodiment. The reason for this is described below with reference to FIG. 12 to FIG. 14. Note that the conventional stylus pen herein refers to a stylus pen in which the entire pen is configured of a conductor and its pen point is configured of a hard conductive material, for example, as depicted in FIG. 16 and FIG. 17.

FIG. 12 is a diagram describing a problem when the conventional stylus pen is tiled at 30° with respect to the input surface of the touch panel 2a. In the example depicted in this drawing, the user tilts the stylus pen at 30° with respect to the input surface of the touch panel 2a to stroke the input surface. Here, the tilt angle of the stylus pen with respect to the direction perpendicular to the input surface is 60°. In this case, since the touch detection position of the pen point on the touch panel 2a varies, even if the pen point linearly moves, its paths become jagged as depicted in (b) of FIG. 12.

The cause for this is that a range where a change in capacitance appears is widened due to an increase of the detection range of the conductive portion, as depicted in (c) of FIG. 12. A distribution of magnitudes of change in capacitance in the range depicted in (c) of FIG. 12 is depicted in (d) of FIG. 12. As depicted in (c) and (d) of FIG. 12, the shape of this distribution is greatly asymmetric in an x direction. This asymmetricity causes a difference (that is, misalignment) between the actual touch position and the calculated barycenter position of the distribution.

The capacitance of the touch panel is not uniform in the input surface and varies subtly depending on the location. Thus, even if ranges at two locations where a change in capacitance appears are identical in size, the distribution of magnitudes of changes at each location may not be the same.

If the range in the touch panel 2a where a change in capacitance appears is increased by greatly tilting the conventional stylus pen with respect to the perpendicular direction of the input surface, the calculated barycenter position of the distribution is greatly deviated from the actual touch position on the input surface. Even if the pen point moves over the input surface, display of reproducing the movement of the pen point can be made as long as the difference between the actual touch position and the calculated barycenter position is uniform, even if a touch input path is displayed at the calculated barycenter position. However, since the range of the detected distribution changes depending on the location due to the influences of the difference in capacitance of the touch panel depending on the location, the difference between the actual touch position of the pen point and the calculated barycenter position also changes depending on the location. This disables high-fidelity display of the movement of the pen point, and its paths become jagged as depicted in (b) of FIG. 12.

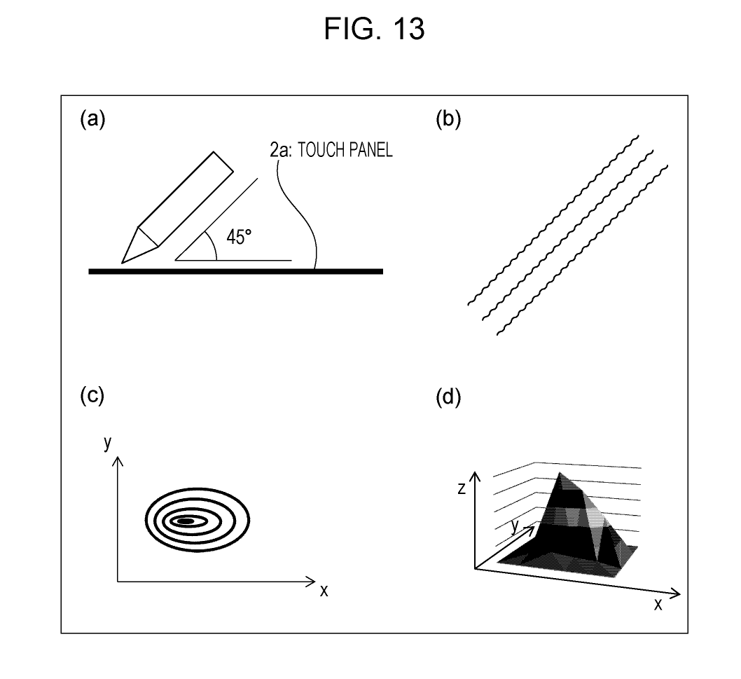

FIG. 13 is a diagram describing a problem when the conventional stylus pen is tilted at 45° with respect to the input surface of the touch panel 2a. In the example of this drawing, the tilt angle of the stylus pen with respect to the direction perpendicular to the input surface is 45°. In this case, as depicted in (b) of FIG. 13, the paths of the stylus pen still become jagged.

The cause for this is that the range where a change in capacitance appears is widened due to an increase of the detection range of the conductive portion, as depicted in (c) of FIG. 13. A distribution of magnitudes of change in capacitance in the range depicted in (c) of FIG. 13 is depicted in (d) of FIG. 13. As depicted in (c) and (d) of FIG. 13, the shape of the distribution is asymmetric in the x direction. This asymmetricity causes a misalignment between the actual touch position and the calculated barycenter position of the distribution, that misalignment varies depending on the location on the input surface, and the path thus becomes jagged as depicted in (b) of FIG. 13. In the example of FIG. 13, the tilt angle of the stylus pen with respect to the direction perpendicular to the input surface is smaller than that of the example of FIG. 12, and the degree of jaggies is thus smaller but nevertheless still poses a problem.

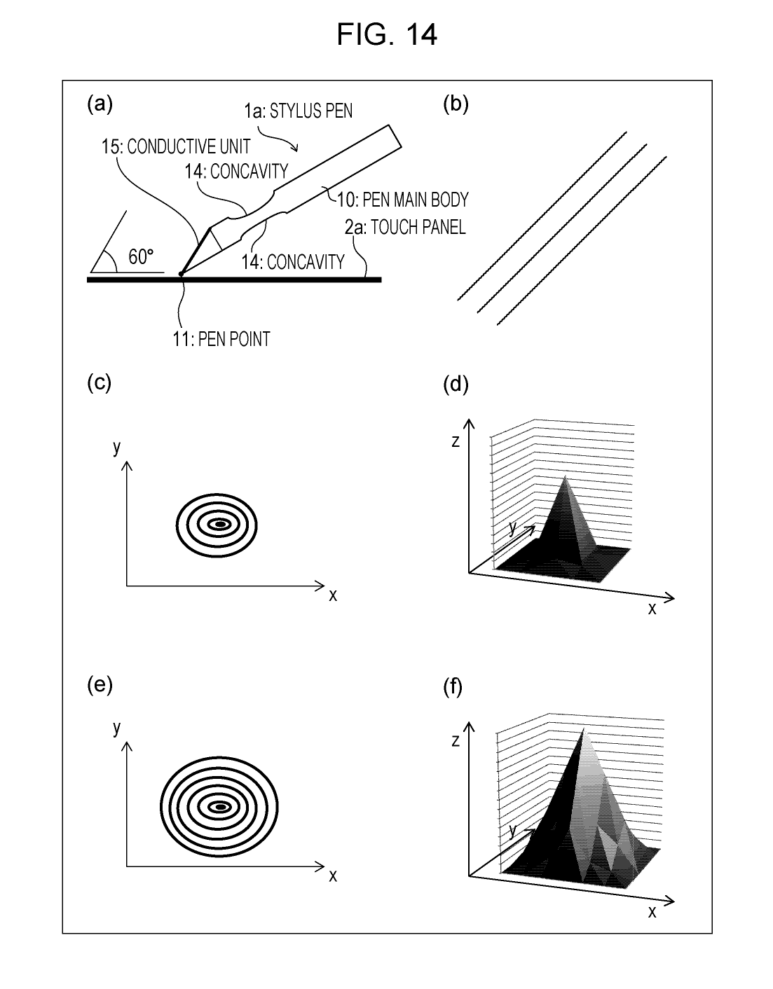

FIG. 14 is a diagram describing a problem when the stylus pen 1a according to the present embodiment is tilted at 30° with respect to the input surface of the touch panel 2a. In the example of this drawing, the user tilts the stylus pen 1a at 30° with respect to the input surface of the touch panel 2a to stroke the input surface. Here, the tilt angle of the stylus pen 1a with respect to the direction perpendicular to the input surface is 60°. In the stylus pen 1a, the tilt angle of the conductive unit 15 with respect to the length direction of the stylus pen 1a is 30°, and the conductive unit 15 is thus tilted at 60° with respect to the input surface. That is, the tilt angle of the conductive unit 15 with respect to the direction perpendicular to the input surface is 30°.

In this case, the detection result of the pen point on the touch panel 2a is uniform, and its path thus becomes smooth without being jagged, as depicted in (b) of FIG. 14. This is because the conductive unit 15 is not so much tilted with respect to the direction perpendicular to the input surface as depicted in (c) of FIG. 14 and the detection range of the conductive unit 15 is thus not increased and the range where a change in capacitance appears becomes narrow. (c) of FIG. 14 depicts capacitances when the diameter of the contact surface of the pen point 11 is small because the load to the stylus pen 1a is small. A distribution of magnitudes of change in capacitance in the range depicted in (c) of FIG. 14 is depicted in (d) of FIG. 14. As depicted in (c) and (d) of FIG. 14, the shape of the distribution is symmetric in the x direction. Since the distribution is symmetric, a misalignment between the actual touch position and the detected barycenter position of the distribution does not occur and, as a result, the paths of thin lines become smooth as depicted in (b) of FIG. 14.

(d) of FIG. 14 depicts capacitances when the diameter of the contact surface of the pen point 11 is large because the load to the stylus pen 1a is large. A distribution of magnitudes of change in capacitance in the range depicted in (d) of FIG. 14 is depicted in (e) of FIG. 14. As depicted in (d) and (e) of FIG. 14, the shape of the distribution is symmetric in the x direction even when the diameter of the contact surface of the pen point 11 is large and the distribution of capacitances are thus wider. Since the distribution is symmetric, a misalignment between the actual touch position and the detected barycenter position of the distribution does not occur and, as a result, a path of a thick line becomes smooth, although not particularly depicted.

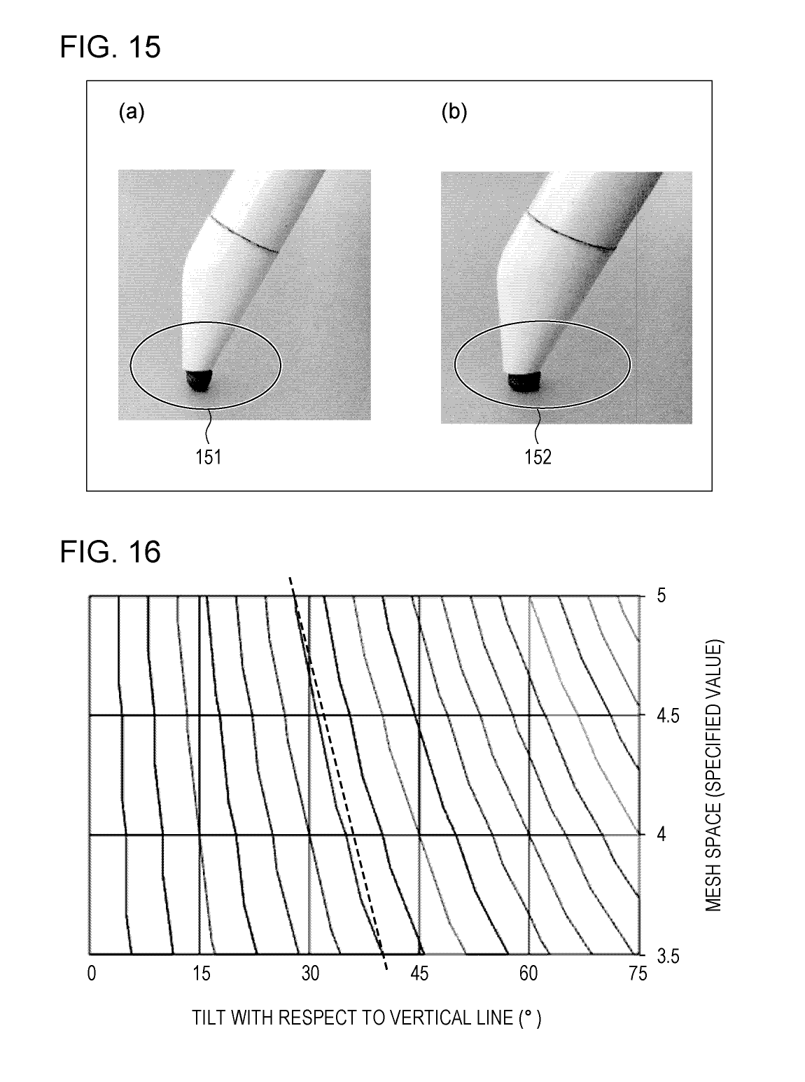

FIG. 15 is a diagram depicting examples (photographs) of implementation of the stylus pen 1a according to the present embodiment. (a) of FIG. 15 depicts a photograph of the stylus pen 1a when the given load is small. (b) depicts a photograph of the stylus pen 1a when the given load is large. As depicted in an oval 151 in (a) of FIG. 15, the pen point 11 is not deformed when a small load is given to the stylus pen 1a, and the contact surface of the pen point 11 with respect to the touch panel 2a thus becomes small. This causes a thin line to be rendered on the touch panel 2a. On the other hand, as depicted in an oval 152 in (b) of FIG. 15, the pen point 11 is deformed when a large load is given to the stylus pen 1a, and the contact surface of the pen point 11 with respect to the touch panel 2a thus becomes large. This causes a thick line to be rendered on the touch panel 2a.

As described above, when the tilt angle of the conductive unit 15 with respect to the direction perpendicular to the input surface is smaller, the range in the touch panel 2a where a change in capacitance appears is narrower. This makes the difference between the calculated barycenter position and the actual touch position smaller. When the range where a change in capacitance appears is narrower, fluctuations of the difference between the calculated barycenter position and the actual touch position depending on the location is subtle even if the distribution of the measured magnitudes of change in capacitance is changed by the influences of the difference in capacitance of the touch panel depending on the location. This is substantially the same as that the difference is uniform irrespective of the location on the input surface. Therefore, even if the stylus pen 1a according to the present embodiment is used as tilted at 60° with respect to the input surface of the touch panel 2a as depicted in (a) of FIG. 14, the displayed paths of the touch position are smooth ones reproducing the motion of the pen point 11 with high fidelity as depicted in (b) of FIG. 14.

In the touch input system 100a according to the present embodiment, the difference between the calculated barycenter position and the actual touch position of the pen point 11 is uniform irrespective of the location on the input surface. This means the same as that a difference between a difference at a location and a difference at another location is equal to or smaller than a minimum recognition unit (minimum display unit) on the display surface even if the difference between the calculated barycenter position and the actual touch position varies depending on the location on the input surface.

### (Relation Between Mesh Space and Misalignment)

As described above, a shift of the barycenter position in the distribution occurs because the area of the conductive portion of the tilted stylus pen detected on the touch panel influences the shape of the distribution of magnitudes of change in capacitance in the touch panel to make the distribution asymmetric. The degree of this problem varies in accordance with a mesh space of a capacitance in the touch panel.

In a capacitive touch panel, a capacitance is generated at a certain spacing called mesh space. When a distribution of magnitudes of change in capacitance is measured and the barycenter position of the distribution is calculated, a spread of the distribution in a certain region in the input surface is used for calculation. In a touch panel with a smaller mesh space, the capacitances at more intersection points included in the certain region change, compared with a touch panel with a larger mesh space. Therefore, in the touch panel with a smaller mesh space, the barycenter position can be calculated by using a larger amount of data, and influences of the difference in capacitance for each location in the touch panel can thus be averaged. As a result, an error between the position of the pen point and the barycenter position occurring due to the tilt of the stylus pen does not greatly fluctuate even if the touched location changes.

On the other hand, in the touch panel with a larger mesh space, the barycenter position has to be found by using a less amount of data, and influences of the difference in capacitance for each location in the touch panel are thus greatly received. This poses a problem in which the difference between the pen point position and the barycenter position occurring due to the tilt of the stylus pen greatly fluctuates when the location of the touch position changes.

FIG. 16 is a diagram depicting a relation between tilts of the conventional stylus pen and misalignment of the barycenter position with respect to the mesh space of the touch panel. In FIG. 16, the horizontal axis represents tilts of the stylus pen, and the vertical axis represents mesh spaces. A distribution of shifts of the barycenter position is represented as contour lines. The vertical axis represents a general range of mesh spaces in the touch panel corresponding to pen touch detection as specified values. In other words, the mesh space in the touch panel for pen touch detection is in the range indicated by the vertical axis of FIG. 16.

As depicted in this drawing, when the tilt angle of the stylus pen 1a with respect to the direction perpendicular to the input surface is larger, the shift of the barycenter position is larger. Also when the mesh space is larger, the shift of the barycenter position is larger. When the tilt angle of the stylus pen 1a with respect to the direction perpendicular to the input surface is large, the area of the conductive portion occurring by the tilt of the stylus pen 1a and detected on the touch panel increases. On the other hand, when the mesh space is large, an error between the actual touched position of the pen point and the barycenter position in the distribution of detected magnitudes of change in capacitance is larger.

A dotted line in FIG. 16 indicates a boundary line of a barycenter misalignment capable of ensuring reproduction of a path of the stylus pen on the touch panel. In the contour lines of FIG. 16, reproduction of a path of the stylus pen can be ensured under the condition on the left side of the dotted line. On the other hand, reproduction of a path of the stylus pen fails to be ensured under the condition on the right side of the dotted line. If the mesh space is small, reproduction of a path of the stylus pen can be ensured in a range of tilt angles of the stylus pen with respect to the direction perpendicular to the input surface from 0° to approximately 40°. Conversely, if the mesh space is large, reproduction of a path of the stylus pen can be ensured in a range of tilt angles of the stylus pen with respect to the input surface from 0° to 30°.

Even if the mesh space is the same, the magnitude of noise influencing the magnitude of the detected change in capacitance varies in accordance with the pattern shape and material of the drive lines and the sense lines and the thickness of the glass cover. In consideration of these noise influences, FIG. 16 depicts the boundary line on the touch panel having a pattern shape and material and a thickness of the glass cover with the worst noise. In consideration of this excessive margin, on the touch panel for pen touch detection, it can be found that reproduction of a path of the stylus pen can be ensured irrespective of the mesh space if the tilt angle of the stylus pen with respect to the direction perpendicular to the input surface is within 30°.

As depicted in (a) to (c) of FIG. 11, in a range of normal use of the stylus pen 1a according to the present embodiment, the tilt angle of the conductive unit 15 with respect to the direction perpendicular to the input surface is 0° to 30°. On the other hand, as depicted in FIG. 16, if the tilt angle of the stylus pen the entire of which is made of a conductive material with respect to the input surface with reference to the direction perpendicular to the input surface is within 30°, reproduction of a path of the stylus pen can be ensured irrespective of the mesh space. Therefore, the stylus pen 1a according to the present embodiment can ensure reproduction of a path at the touch position on the input surface within the range of normal use.

Also, when the user holds the stylus pen 1a, the user's hand makes contact with the conductive portion connected to the conductive unit 15, and both of the pen point 11 and the conductive unit 15 thus have the potential as that of humans (grounded). This makes the pen point 11 and the conductive unit 15 not in a stray state, and the distribution of magnitudes of change in capacitance thus becomes more stable. As a result, the touch position can be detected with higher accuracy.

### Third Embodiment

A third embodiment according to the present invention is described below based on FIG. 17 to FIG. 20.

FIG. 17 is a perspective view depicting the structure of main parts of a touch input system 100b according to the present embodiment. As depicted in this drawing, the touch input system 100b is configured of a stylus pen 1b (information input pen) and a capacitive touch panel 2b.

FIG. 18 is a diagram depicting the structure of main parts of the stylus pen 1b and the touch panel 2b configuring the touch input system 100b according to the present embodiment. The stylus pen 1b further includes a movable unit 16 and a fixing unit 17, in addition to each member included in the stylus pen 1a of the second embodiment. The touch panel 2b further includes an approach detection unit 40 and a fixation instruction unit 41, in addition to each member included in the touch panel 2a of the second embodiment.

Although not particularly depicted, as with the first embodiment of the present invention, the pen point 11 according to the present embodiment is configured of the conductive rubber 12 and the conductive fiber cloth 13 wound around the periphery of the conductive rubber 12. This makes the thickness of the pen point 11 change with a resolution of at least 1024 steps in accordance with the load given to the stylus pen 1b at the time of use. Therefore, when the user uses the stylus pen 1b to write a character on the touch panel 2b, the thickness of a line being rendered flexibly changes in accordance with the load.

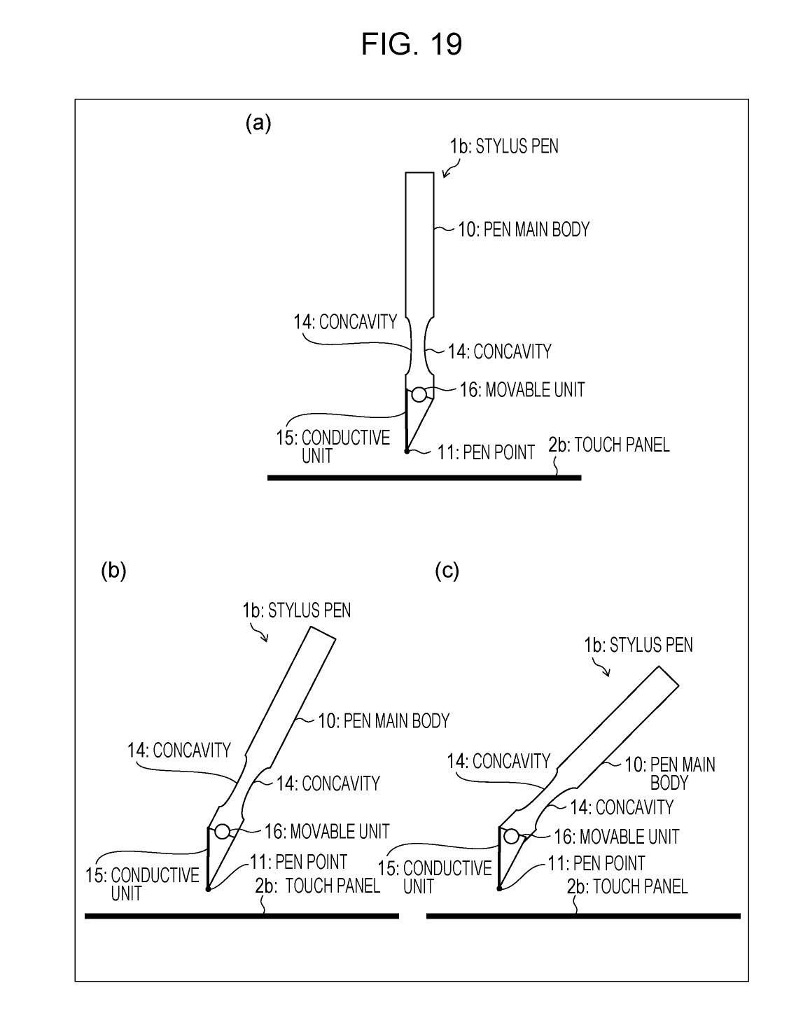

FIG. 19 is a diagram depicting a state of the stylus pen 1b before detected by the touch panel 2b. As depicted in this drawing, the movable unit 16 moves a portion including the pen point 11 and the conductive unit 15 when the pen point 11 of the stylus pen 1b is away from the input surface of the touch panel 2b at a predetermined distance or farther. In other words, when an approach of the stylus pen 1b is not detected by the touch panel 2b, the movable unit 16 moves the portion including the pen point 11 and the conductive unit 15 so that the tilt angle of the conductive unit 15 in the length direction with respect to the input surface of the touch panel 2b is a predetermined angle at which a difference between the contact position of the pen point 11 on the input surface and the barycenter position in the distribution of magnitudes of change in capacitance occurring due to a contact of the pen point 11 with the input surface is uniform irrespective of the location on the input surface (contact position of the pen point 11). The predetermined angle satisfying this condition is, for example, 60° to 90°, as described in the second embodiment.

In examples of (a) to (c) of FIG. 19, the portion including the pen point 11 and the conductive unit 15 moves so that the pen point 11 becomes naturally oriented to the ground and the conductive unit 15 becomes parallel to a gravity direction, at whichever angle the pen main body 10 is tilted. Here, the conductive unit 15 stands upright with respect to the input surface. That is, the length direction of the conductive unit 15 and the input surface form an angle of 90°.

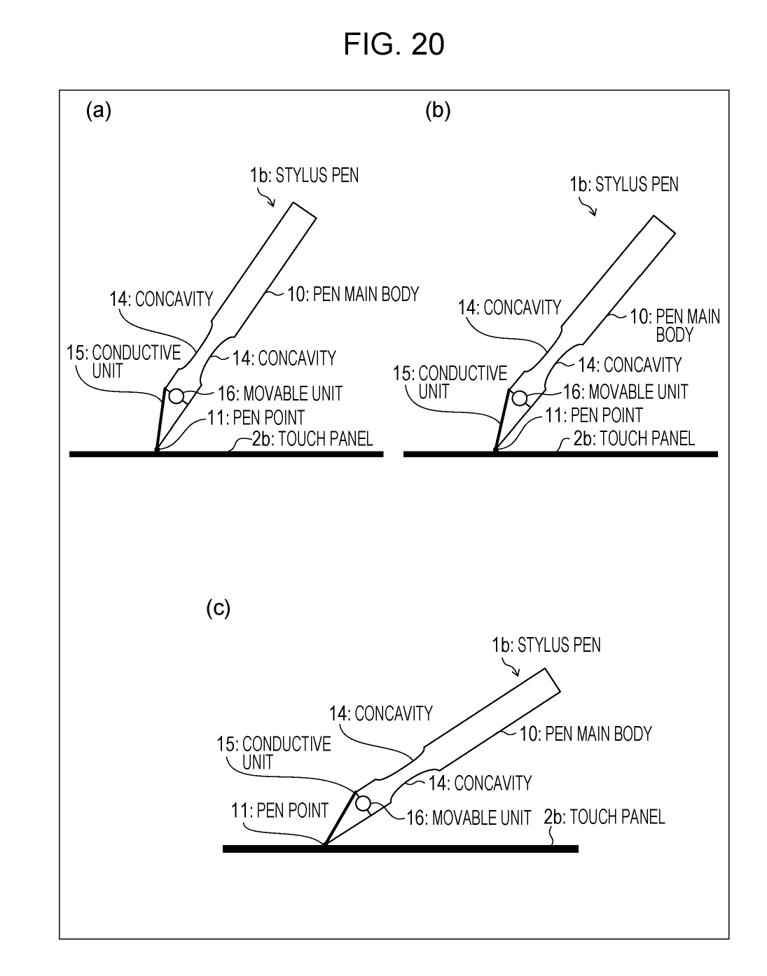

FIG. 20 is a diagram depicting a state of the stylus pen 1b after detected by the touch panel 2b. When the pen point 11 of the stylus pen 1b approaches the input surface of the touch panel 2b within a certain distance, the approach detection unit 40 in the touch panel 2b detects as such, and notifies the fixation instruction unit 41 as such. The stylus pen 1b and the touch panel 2b can wirelessly communicate with each other. Upon reception of the notification from the approach detection unit 40, the fixation instruction unit 41 notifies the stylus pen 1b that the pen point 11 is detected by the touch panel 2b, and makes an instruction for fixing the pen point 11.

In the stylus pen 1b, the fixing unit 17 receives this instruction. Upon reception of this instruction, the fixing unit 17 instructs the movable unit 16 to fix the portion including the pen point 11 and the conductive unit 15. This causes the movable unit 16 to fix the portion including the pen point 11 and the conductive unit 15.

When the pen point 11 of the stylus pen 1b in the state depicted in (b) of FIG. 19 is brought into contact with the input surface of the touch panel 2b while this tilt angle is maintained, the state of the stylus pen 1b becomes as depicted in (a) of FIG. 20. Here, since the portion including the pen point 11 and the conductive unit 15 is fixed, as depicted in (b) or (c) of FIG. 20, even if the entire stylus pen 1b is further tilted toward the input surface, the portion including the pen point 11 and the conductive unit 15 does not move relatively to the pen main body 10.

As described above, before the stylus pen 1b is detected by the touch panel 2b, the length direction of the conductive unit 15 stands upright with respect to the input surface of the touch panel 2b. That is, the tilt angle of the conductive unit 15 with respect to the input surface is 90°. This causes the conductive unit 15 to be fixed in a state with the tilt angle with respect to the input surface being 90° when the pen point 11 of the stylus pen 1b makes contact with the touch panel 2b. Thereafter, while the user is continuously holding the touch panel 2b, there is a possibility that the stylus pen 1b may be tilted more with respect to the input surface. However, the stylus pen 1b is not tilted as exceeding 60° with respect to the direction perpendicular to the input surface in the range of normal use of the touch panel 2b, and the tilt angle of the conductive unit 15 with respect to the input surface is thus kept within a range of 60° to 90° at the time of use of the stylus pen 1b.

Therefore, in the stylus pen 1b according to the present embodiment, as with the stylus pen 1a of the first embodiment, the influences of the conductive unit 15 on the distribution of magnitudes of change in capacitance caused by the pen point 11 can be reduced. This can reduce variability of the touch detection position when the stylus pen 1b is tilted even if the pen point 11 is sufficiently small.

### Fourth Embodiment

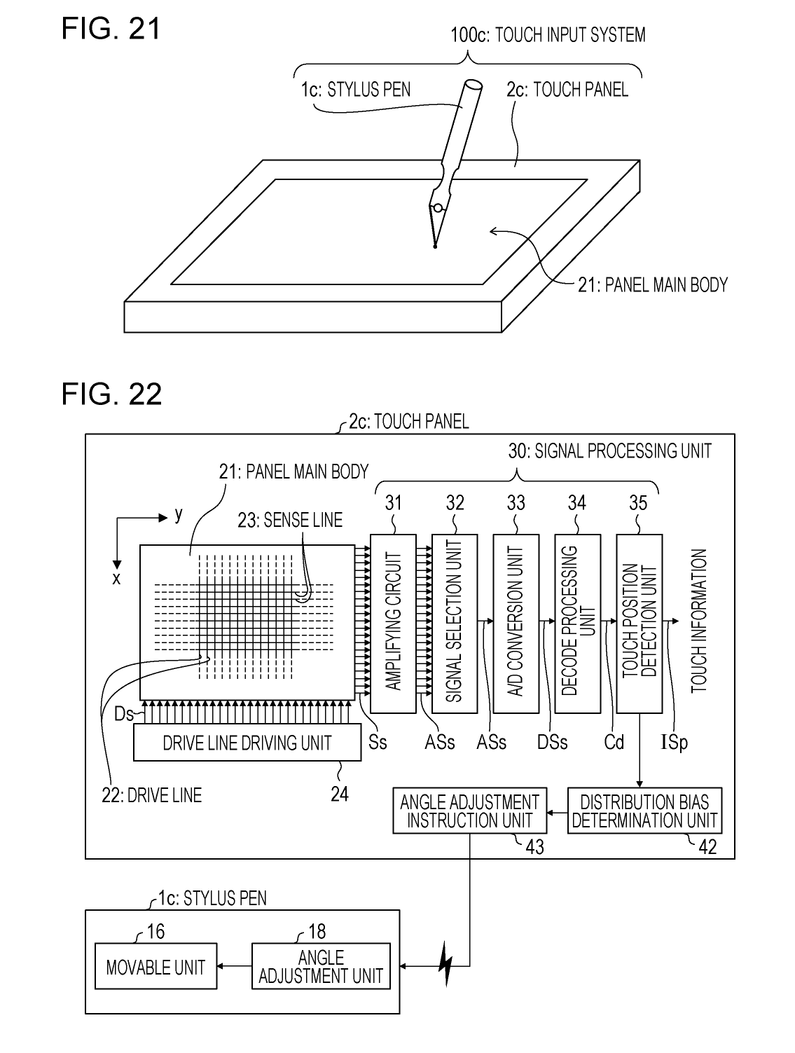

A fourth embodiment according to the present invention is described below based on FIG. 21 to FIG. 23.

FIG. 21 is a perspective view depicting the structure of main parts of a touch input system 100c according to the present embodiment. As depicted in this drawing, the touch input system 100c is configured of a stylus pen 1c (information input pen) and a capacitive touch panel 2c.

FIG. 22 is a diagram depicting the structure of main parts of the stylus pen 1c and the touch panel 2c configuring the touch input system 100c according to the present embodiment. The stylus pen 1c further includes a movable unit 16 and an angle adjustment unit 18, in addition to each member included in the stylus pen 1a of the second embodiment. The touch panel 2c further includes a distribution bias determination unit 42 and an angle adjustment instruction unit 43, in addition to each member included in the touch panel 2a of the second embodiment.

Although not particularly depicted, as with the first embodiment of the present invention, the pen point 11 according to the present embodiment is configured of the conductive rubber 12 and the conductive fiber cloth 13 wound around the periphery of the conductive rubber 12. This makes the thickness of the pen point 11 change with a resolution of at least 1024 steps in accordance with the load given to the stylus pen 1c at the time of use. Therefore, when the user uses the stylus pen 1c to write a character on the touch panel 2c, the thickness of a line being rendered flexibly changes in accordance with the load. As a result, the change in thickness of a line in accordance with the change in pressing force of the stylus pen 1c can be set to have high accuracy at a practical level.

In the stylus pen 1c of the present embodiment, as with the third embodiment, the movable unit 16 can move the portion including the pen point 11 and the conductive unit 15. In the present embodiment, the movable unit 16 includes a stepping motor and a control circuit. By these workings, the tilt angle of the portion including the pen point 11 and the conductive unit 15 with respect to the pen main body 10 is adjusted.

In the touch panel 2c, the touch position detection unit 35 outputs data indicating a distribution of measured magnitudes of change in capacitance to the distribution bias determination unit 42. Based on the inputted data, the distribution bias determination unit determines whether a bias of the distribution exceeds a predetermined reference value, and notifies the angle adjustment instruction unit 43 of the result. The stylus pen 1c and the touch panel 2c can wirelessly communicate with each other. Upon receiving the notification that the bias exceeds the reference value, the angle adjustment instruction unit 43 transmits, to the stylus pen 1c, information indicating in which direction the distribution is biased on the x axis, and also instructs the stylus pen 1c to adjust the angle of the pen point 11 to an angle for more decreasing the bias of the distribution.

In the stylus pen 1c, the angle adjustment unit 18 receives this information and instruction. By controlling the stepping motor and the control circuit of the movable unit 16, the angle adjustment unit 18 changes the angles of the pen point 11 and the conductive unit 15 to angles for more decreasing the bias of the distribution.

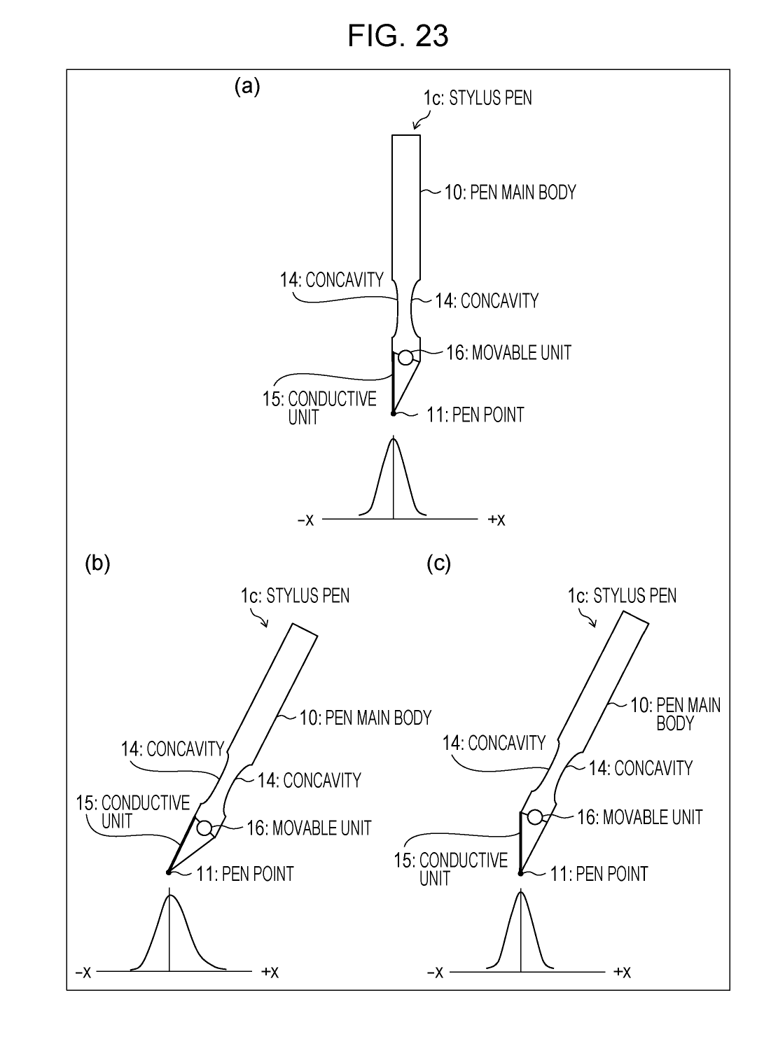

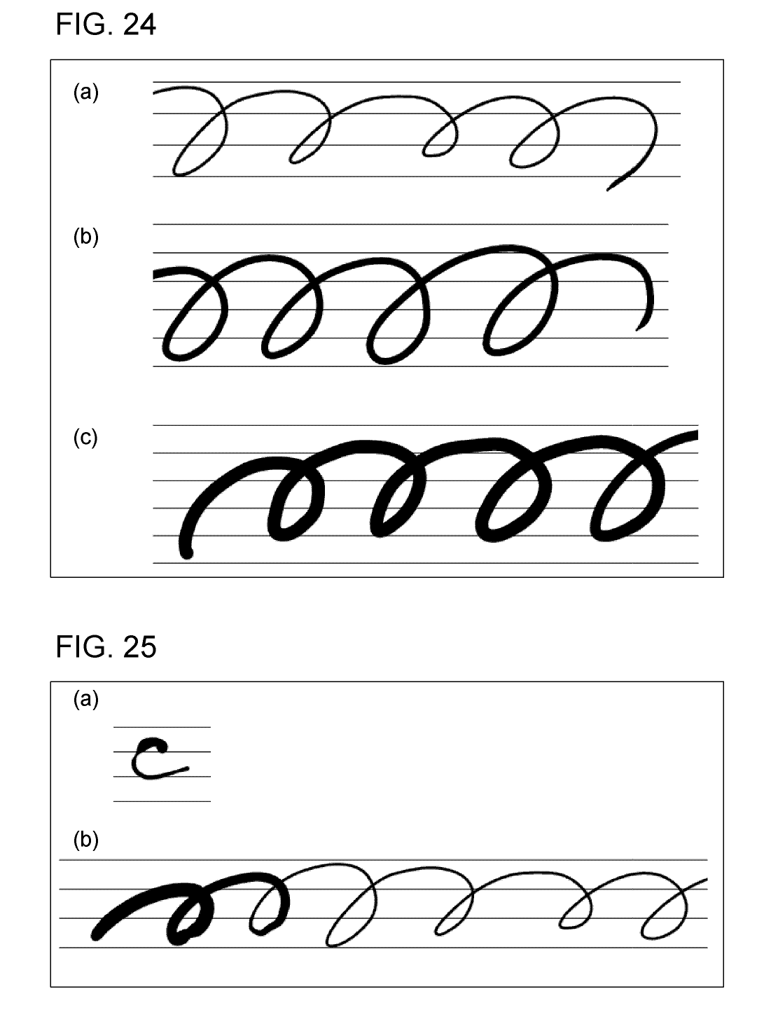

FIG. 23 is a diagram depicting a state in which the tilt of the conductive unit 15 is adjusted in accordance with the bias of the distribution of magnitudes of change in capacitance in the stylus pen 1c. The stylus pen 1c is depicted on an upper side of each of (a) to (c) of FIG. 23, and a distribution of magnitudes of change in capacitance is depicted on a lower side thereof.

When the stylus pen 1c makes contact with the input surface in the state depicted in (a) of FIG. 23, the length direction of the conductive unit 15 is perpendicular to the input surface, and no bias is thus present in the distribution of the measured magnitudes of change in capacitance. Therefore, the distribution bias determination unit 42 determines that the bias of the distribution does not exceed the predetermined reference value, and notifies the angle adjustment instruction unit 43 as such. Upon reception of this, the angle adjustment instruction unit 43 does not instruct the stylus pen 1c to make angle adjustment, and the stylus pen 1c thus does not adjust the tilt angle of the conductive unit 15.

On the other hand, when the stylus pen 1c makes contact with the input surface in the state depicted in (b) of FIG. 23, the length direction of the conductive unit 15 is tilted at a certain angle with respect to the input surface, and a bias is thus present in the distribution of the measured magnitudes of change in capacitance. In the example of this drawing, the distribution is biased in a +x direction on the x axis. The distribution bias determination unit 42 determines that this bias exceeds the predetermined reference value, and notifies the angle adjustment instruction unit 43 as such. Upon reception of this, the angle adjustment instruction unit 43 notifies that the distribution is biased in the +x direction and instructs the stylus pen 1c to adjust the angle of the conductive unit 15. Upon reception of this, the angle adjustment unit 18 adjusts the tilt angle of the conductive unit 15 to an angle for reducing the bias of the distribution in the +x direction. Specifically, the movable unit 16 is controlled so as to more increase the tilt angle of the conductive unit 15 with respect to the input surface.

In the example depicted in (c) of FIG. 23, by receiving the control of the angle adjustment unit 18, the movable unit 16 moves the conductive unit 15 so that the tilt angle of the conductive unit 15 with respect to the direction perpendicular to the input surface is 0°. This can completely inhibit the influences of the conductive unit 15 on the distribution, and the bias of the distribution can thus be resolved. As a result, symmetricity of the distribution can be kept, and variability of the detected touch position can be completely resolved.

As described in the second and third embodiments, variability of the detected touch position can be reduced if the tilt angle of the conductive unit 15 with respect to the input surface is a predetermined angle (60° to 90°) at which the difference between the contact position of the pen point 11 and the barycenter position in the distribution is uniform irrespective of the location on the input surface (contact position of the pen point 11). In other words, the bias (asymmetricity) of the distribution when the tilt angle of the conductive unit 15 is within this range is sufficiently allowable without influencing variability of the touch position. Thus, when receiving, from the touch panel 2c, a notification that the measured distribution has a certain bias or more, it is sufficient for the angle adjustment unit 18 to control the movable unit 16 so that the tilt angle of the conductive unit 15 with respect to the input surface comes closer to an angle in the range of 60° to 90°, thereby adjusting the tilt angle of the conductive unit 15.

To achieve this, it is sufficient to obtain, in advance, data indicating a relative relation between the tilt angle of the conductive unit 15 with respect to the input surface and the degree of the bias of the distribution measured at that time and provide the relation to the stylus pen 1c. When adjusting the tilt angle of the conductive unit 15 with respect to the input surface to a desired angle, it is sufficient for the angle adjustment unit 18 to repeatedly adjust the tilt angle of the conductive unit 15 until bias data corresponding to the desired angle is received from the touch panel 2c.

As described above, in the stylus pen 1c according to the present embodiment, as with the stylus pen 1a of the first embodiment, the bias of the distribution of magnitudes of change in capacitance occurring by the pen point 11 can be reduced. This can reduce variability of the touch detection position when the stylus pen 1c is tilted even if the pen point 11 is sufficiently small. Therefore, jaggies on a path of a fine line rendered on the touch panel 2c can be avoided when the diameter of the contact surface of the pen point 11 with respect to the touch panel 2c is small because the load given to the stylus pen 1 is small. Similarly, jaggies on a path of a thick line rendered on the touch panel 2c can also be avoided when the diameter of the contact surface of the pen point 11 with respect to the touch panel 2c is large because the load given to the stylus pen 1 is large.

### CONCLUSION

An information input pen according to a first mode of the present invention is an information input pen for inputting information onto a capacitive touch panel, the information input pen including a pen main body and a conductive pen point configured of a conductive rubber and a conductive fiber cloth wound around the conductive rubber.

According to the above-described structure, the pen point of the information input pen has both flexibility of the conductive rubber and the stretching property of the conductive fiber cloth, and is also very soft. Therefore, when the user uses the information input pen to write a line on the input surface of the touch panel while changing the load given to the information input pen, the diameter (thickness) of the contact surface of the pen point changes as appropriate in accordance with the change in pushing strength (that is, pressing force) to the pen point. As a result, a “sweep” of the rendered line is accurately represented as intended by the user on the touch panel. That is, by using the information input pen, the user can render a line accurately corresponding to a natural handwriting motion on the touch panel.

In the information input pen according to a second mode of the present invention, in the above-described first mode, a resolution of a change of a thickness of the pen point in accordance with a pressing force when the touch panel is pushed by the information input pen is equal to or more than 1024 steps.

According to the above-described structure, the change in thickness of a line in accordance with the change in pressing force of the information input pen can be set to have high accuracy at a practical level.

In the information input pen according to a third mode of the present invention, in the above-described first or second mode, the pen main body is non-conductive, the information input pen further includes a conductive unit electrically connected to the pen point and diagonally arranged with respect to a length direction of the pen main body, and when the pen point makes contact with or approaches an input surface of the touch panel, a tilt angle of the conductive unit in the length direction with respect to the input surface of the touch panel is a predetermined angle at which a difference between a contact position or an approach position of the pen point on the input surface and a barycenter position in a distribution of magnitudes of change in capacitance occurring by the pen point making contact with or approaching the input surface is uniform irrespective of a location on the input surface.

According to the above-described structure, when the pen point makes contact with or approaches the input surface of the touch panel, a difference between the actual contact position or approach position of the pen point with respect to the input surface and the barycenter position in the distribution of the measured magnitudes of change in capacitance is uniform irrespective of the location on the input surface. This can reduce the influences of the conductive unit on the distribution of the magnitudes of change in capacitance, and variability of the detected contact position or approach position can be reduced.

Also, even if the tilt angle of the information input pen with respect to the direction perpendicular to the input surface is increased, the tilt angle of the conductive unit with respect to the direction perpendicular to the input surface is still small. Therefore, even if the stylus pen is greatly tilted with respect to the direction perpendicular to the input surface, variability of the detected contact position or approach position can be reduced.

Furthermore, the influences of the conductive unit on the distribution of the measured magnitudes of change in capacitance are small, and the pen point thus does not have to be increased to decrease the influences. Therefore, even if the pen point is sufficiently small, variability of the detected contact position or approach position can be reduced when the stylus pen is greatly tilted.

In the information input pen according to a fourth mode of the present invention, in the above-described first or second mode, the pen main body is non-conductive, the information input pen further includes a conductive unit electrically connected to the pen point, a movable unit which moves the conductive unit so that, when a contact or an approach of the information input pen is not detected by the touch panel, the tilt angle of the conductive unit in the length direction with respect to the input surface of the touch panel is the predetermined angle at which the difference between the contact position or the approach position of the pen point on the input surface and the barycenter position in the distribution of the magnitudes of change in capacitance occurring by the pen point making contact with or approaching the input surface is uniform irrespective of the location on the input surface, and a fixing unit which fixes the conductive unit when the approach of the information input pen is detected by the touch panel.

According to the above-described structure, after the information input pen is detected by the touch panel, the difference between the actual contact position or approach position of the pen point with respect to the input surface and the barycenter position in the distribution of measured magnitudes of change in capacitance is uniform irrespective of the location on the input surface. This can reduce the influences of the conductive unit on the distribution of magnitudes of change in capacitance, and variability of the detected contact position or approach position can thus be reduced.

Also, even if the tilt angle of the information input pen with respect to the direction perpendicular to the input surface is increased, the tilt angle of the conductive unit with respect to the direction perpendicular to the input surface is still small. Therefore, even if the stylus pen is greatly tilted with respect to the direction perpendicular to the input surface, variability of the detected contact position or approach position can be reduced.

Furthermore, the influences of the conductive unit on the distribution of the measured magnitudes of change in capacitance are small, and the pen point thus does not have to be increased to decrease the influences. Therefore, even if the pen point is sufficiently small, variability of the detected contact position or approach position can be reduced when the stylus pen is greatly tilted.

In the information input pen according to a fifth mode of the present invention, in the above-described first or second mode, the pen main body is non-conductive, the information input pen further includes a conductive unit electrically connected to the pen point, and a movable unit which moves the conductive unit so that, when a notification that the distribution of the capacitances measured by the touch panel has a certain bias or more is received from the touch panel, the tilt angle of the conductive unit in the length direction with respect to the input surface of the touch panel is made closer to the predetermined angle at which the difference between the contact position or the approach position of the pen point on the input surface and the barycenter position in the distribution is uniform irrespective of the location on the input surface.

According to the above-described structure, when the distribution of the measured magnitudes of change in capacitance has a bias, the angle of the conductive unit is adjusted so that the difference between the actual contact position or approach position of the pen point with respect to the input surface and the barycenter position in the distribution of the measured magnitudes of change in capacitance is uniform irrespective of the location on the input surface. When this adjustment is completed, the influences of the conductive unit on the distribution of the magnitudes of change in capacitance can be reduced, and variability of the detected contact position or approach position can thus be reduced.

Also, after the completion of the adjustment, even if the tilt angle of the information input pen with respect to the direction perpendicular to the input surface is increased, the tilt angle of the conductive unit with respect to the direction perpendicular to the input surface is still small. Therefore, even if the stylus pen is greatly tilted with respect to the direction perpendicular to the input surface, variability of the detected contact position or approach position can be reduced.

Furthermore, after the completion of the adjustment, the influences of the conductive unit on the distribution of the measured magnitudes of change in capacitance are small, and the pen point thus does not have to be increased to decrease the influences. Therefore, even if the pen point is sufficiently small, variability of the detected contact position or approach position can be reduced when the stylus pen is greatly tilted.

In the information input pen according to a sixth mode of the present invention, in any of the above-described third to fifth modes, the predetermined angle is equal to or larger than 60° and equal to or smaller than 90°.

According to the above-described structure, variability of the detected contact position or approach position can be reduced irrespective of the mesh space of the touch panel.

An information input system according to a seventh mode includes the information input pen according to any one of the above-described first to sixth modes and a capacitive touch panel.

According to the above-described structure, it is possible to provide an information input system capable of rendering a line accurately corresponding to a natural handwriting motion on a touch panel.

The present invention is not meant to be limited to each embodiment described above, and can be variously modified in a range described in the claims, and an embodiment obtained by appropriately combining technical means respectively disclosed in different embodiments is also included in the technical range of the present invention. Furthermore, by combining the technical means respectively disclosed in each embodiment, a new technical feature can be formed.

### INDUSTRIAL APPLICABILITY

The present invention can be used as an information input pen for inputting information onto a capacitive touch panel and an information input system including the information input pen and the capacitive touch panel.

### REFERENCE SIGNS LIST

1, 1a to is stylus pen (information input pen)
2, 2a to 2c touch panel
10 pen main body
11 pen point
12 conductive rubber
13 conductive fiber cloth
14 concavity
15 conductive unit
16 movable unit
17 fixing unit
40 approach detection unit
41 fixation instruction unit
42 distribution bias determination unit
43 angle adjustment instruction unit
100, 100a to 100c touch input system (information input system)

1-7. (canceled)

8. An information input pen for inputting information onto a capacitive touch panel, the information input pen comprising:
a pen main body; and
a conductive pen point configured of a conductive rubber and a conductive fiber cloth wound around the conductive rubber,
wherein
the pen main body is non-conductive,
the information input pen further includes a conductive unit electrically connected to the pen point and diagonally arranged with respect to a length direction of the pen main body, and
when the pen point makes contact with or approaches an input surface of the touch panel, a tilt angle of the conductive unit in the length direction with respect to the input surface of the touch panel is a predetermined angle at which a difference between a contact position or an approach position of the pen point on the input surface and a barycenter position in a distribution of magnitudes of change in capacitance occurring by the pen point making contact with or approaching the input surface is uniform irrespective of a location on the input surface.

9. An information input pen for inputting information onto a capacitive touch panel, the information input pen comprising:
a pen main body; and
a conductive pen point configured of a conductive rubber and a conductive fiber cloth wound around the conductive rubber,
wherein
the pen main body is non-conductive,
the information input pen further includes
a conductive unit electrically connected to the pen point,
a movable unit which moves the conductive unit so that, when a contact or an approach of the information input pen is not detected by the touch panel, the tilt angle of the conductive unit in the length direction with respect to the input surface of the touch panel is the predetermined angle at which the difference between the contact position or the approach position of the pen point on the input surface and the barycenter position in the distribution of the magnitudes of change in capacitance occurring by the pen point making contact with or approaching the input surface is uniform irrespective of the location on the input surface, and
a fixing unit which fixes the conductive unit when the approach of the information input pen is detected by the touch panel.

10. An information input pen for inputting information onto a capacitive touch panel, the information input pen comprising:
a pen main body; and
a conductive pen point configured of a conductive rubber and a conductive fiber cloth wound around the conductive rubber,
wherein
the pen main body is non-conductive,
the information input pen further includes
a conductive unit electrically connected to the pen point, and
a movable unit which moves the conductive unit so that, when a notification that the distribution of the capacitances measured by the touch panel has a certain bias or more is received from the touch panel, the tilt angle of the conductive unit in the length direction with respect to the input surface of the touch panel is made closer to the predetermined angle at which the difference between the contact position or the approach position of the pen point on the input surface and the barycenter position in the distribution is uniform irrespective of the location on the input surface.

11. The information input pen according to claim 8, wherein
a resolution of a change of a thickness of the pen point in accordance with a pressing force when the touch panel is pushed by the information input pen is equal to or more than 1024 steps.

12. The information input pen according to claim 8, wherein
the predetermined angle is equal to or larger than 60° and equal to or smaller than 90°.

13. An information input system comprising:
the information input pen according to claim 8; and
a capacitive touch panel.

14. The information input pen according to claim 9, wherein
a resolution of a change of a thickness of the pen point in accordance with a pressing force when the touch panel is pushed by the information input pen is equal to or more than 1024 steps.

15. The information input pen according to claim 9, wherein
the predetermined angle is equal to or larger than 60° and equal to or smaller than 90°.

16. An information input system comprising:
the information input pen according to claim 9; and
a capacitive touch panel.

17. The information input pen according to claim 10, wherein
a resolution of a change of a thickness of the pen point in accordance with a pressing force when the touch panel is pushed by the information input pen is equal to or more than 1024 steps.

18. The information input pen according to claim 10, wherein
the predetermined angle is equal to or larger than 60° and equal to or smaller than 90°.

19. An information input system comprising:
the information input pen according to claim 10; and
a capacitive touch panel.
